(19) United States
(12) Patent Application Publication
(10) Pub. No.: US 2026/0142850 A1
(43) Pub. Date: May 21, 2026

(54) TRANSMITTING/RECEIVING DEVICE FOR A STATION OF A SERIAL BUS SYSTEM, AND METHOD FOR COMMUNICATION USING DIFFERENTIAL SIGNALS IN A SERIAL BUS SYSTEM

(71) Applicant: Robert Bosch GmbH, Stuttgart (DE)

(72) Inventors: Steffen Walker, Reutlingen (DE); Christian Mages, Stuttgart (DE); Felix Lang, Reutlingen (DE)

(21) Appl. No.: 19/391,329

(22) Filed: Nov. 17, 2025

(30) Foreign Application Priority Data
Nov. 21, 2024 (DE) 10 2024 211 194.5

(51) Int. Cl. H04L 12/40

(52) U.S. Cl. CPC H04L 12/40006

(57) ABSTRACT

A transmitting/receiving device for a station of a serial bus system. The transmitting/receiving device includes a transmission module for transmitting a digital transmit signal as an analog differential signal onto a bus, a reception module for receiving signals from the bus and generating a digital receive signal from the analog differential signal, and a module for ascertaining which of at least two communication standards is used on the bus, to switch the transmission module and the reception module according to the ascertained communication standard. The transmission module has a full bridge including a first and fourth transmission stage connected in series, and a third and second transmission stage connected in series. The transmission module sets resistance values of resistors of the first to fourth transmission stages based on the ascertainment result of the module for ascertainment and generates the analog differential signal with the first to fourth transmission stages.

### CROSS REFERENCE

The present application claims the benefit under 35 U.S.C. § 119 of Germany Patent Application No. DE 10 2024 211 194.5 filed on Nov. 21, 2024, which is expressly incorporated herein by reference in its entirety.

### FIELD

The present invention relates to a transmitting/receiving device for a station of a serial bus system, and to a method for communication using differential signals in a serial bus system.

### BACKGROUND INFORMATION

Serial bus systems have a bus to which stations are connected via a transmitting/receiving device in order to communicate with one another via the bus. The transmitting/receiving device is also called a transceiver. During communication, data are exchanged between the stations, which can be, for example, sensors, control devices in a vehicle or a technical production plant, etc. For data transmission in serial bus systems, there are different standards or data transmission protocols. Conventional serial bus systems with differential signals include, in particular, CAN XL, 10BASE-TIS Ethernet, FlexRay, LVDS (low-voltage differential signaling), and so on.

Each of these serial bus systems uses differential signals with different signal states, which serially signal the data to be exchanged.

It is possible that part of the technical system uses a bus system that uses a different communication standard than a bus system used in another part of the technical system. For example, a CAN bus system is to be used for communication in a vehicle's emergency braking system, whereas a 10BASE-T1S bus system is to be used for communication in a windshield wiper system.

The problem is that the communication in the CAN bus system and the communication in the 10BASE-T1S bus system are not compatible with each other. For example, if at least one control device needs to be replaced due to a defect, a control device that supports the communication standard in the bus system to which the replaced control device was connected is not always available in time.

In addition, the data from some of the vehicle's devices, such as a rain sensor or a warning signal generator, etc., are needed for parts of the technical system that communicate using the different communication standards.

To solve this problem, two devices, in particular two rain sensors and/or warning signal generators, etc., could be used, one of which is connected to the CAN bus system and the other is connected to the 10BASE-T1S bus system.

Alternatively, such a device may have communication devices designed for communication in the CAN bus system and communication devices designed for communication in the 10BASE-T1S bus system.

However, this requires significantly more devices than does a technical system that uses only one communication standard for communication. As a result, the technical system requires more space and becomes significantly more expensive to manufacture and maintain.

### SUMMARY

It is an object of the present invention to provide a transmitting/receiving device for a station of a serial bus system and a method for communication using differential signals in a serial bus system which solve the aforementioned problems. In particular, a transmitting/receiving device for a station of a serial bus system and a method for communication using differential signals in a serial bus system are to be provided, which solve the compatibility problem between different communication standards in a technical system.

The object is achieved by a transmitting/receiving device for a station of a serial bus system having certain features of the present invention. According to an example embodiment of the present invention, the transmitting/receiving device has a transmission module for transmitting a digital transmit signal as an analog differential signal into a bus of the bus system in order to transmit a message to at least one other station of the bus system, a reception module for receiving signals from the bus and for generating a digital receive signal from the analog differential signal, and at least one module for ascertainment which of at least two communication standards is used on the bus, in order to switch the transmission module and the reception module according to the ascertained communication standard on the bus, wherein the transmission module has a full bridge in which a first and fourth transmission stage are connected in series and a third and second transmission stage are connected in series, and wherein the transmission module is designed to set resistance values of resistors of the first to fourth transmission stages on the basis of the ascertainment result of the at least one module for ascertainment and to generate the analog differential signal with the first to fourth transmission stages set in this way.

The transmitting/receiving device according to the present invention, described herein, can use a special module and the digital transmit signal to detect according to which of at least two different communication standards the transmitting/receiving device should behave, and can then adjust the resistors of a full bridge of the transmission module accordingly in order to communicate on the bus in the detected communication standard. The at least two different communication standards include, in particular, at least one standard for 10BASE-T1S and/or one standard for CAN, especially CAN XL.

Advantageously, the transmitting/receiving device according to the present invention can be designed in such a way that no additional terminal or non-standardized inputs need to be provided or reserved by the communication control device, in particular its controller, for detecting the communication standard used on the bus.

The transmitting/receiving device described can thus automatically detect which communication standard a connected communication control device uses, and can set the transmission module accordingly. This allows a very high degree of flexibility in selecting the communication standard for the bus system and thus for the communication control device, provided the transmitting/receiving device described is connected to the bus in an unchanged manner.

An additional advantage is that electrical circuit components, such as the voltage supply, etc., of the transmitting/receiving device described can be used for two different communication standards. As a result, the transmitting/receiving device described can save on semiconductor area. This optimizes the space requirements of the transmitting/receiving device and of the bus system. As a result, the transmitting/receiving device described is extremely resource-efficient and cost-effective.

Due to the design of the transmitting/receiving device of the present invention described herein, the very little effort required to adapt the communication control device to the transmitting/receiving device. In the case of the transmitting/receiving device, only the wiring of the terminals (pins) for the bus lines of the bus needs to be adapted to the communication control device used.

In addition, due to the design of the transmitting/receiving device described, reliable communication with a very low error rate is nevertheless made possible in an uncomplicated and cost-effective manner for at least two different differential bus systems.

The transmitting/receiving device described thereby makes it possible to change the communication standard for existing wiring of transmitting/receiving devices in a comparatively straightforward manner. The reason for this is that the transmitting/receiving device described can be used with minimal configuration effort for bus systems in which communication takes place using different communication standards. If necessary, this also allows an existing device of a technical system, in particular of a vehicle, to be flexibly connected as needed to different bus systems in which communication takes place using different communication standards.

The transmitting/receiving device described is designed to set itself as a CAN SIC transmitting/receiving device and/or CAN XL transmitting/receiving device and/or 10BASE-T1S transmitting/receiving device, depending on the connected communication control device. More precisely, a setting for 10BASE-T1S multi-drop or 10BASE-T1S single-drop is possible. Furthermore, a setting for a bus voltage supply of, for example, 3.3 V or 5.0 V is possible. The single-drop operating mode in 10BASE-T1S is present when only two stations are connected to the bus 40, i.e. a point-to-point connection exists between the stations. The multi-drop operating mode in 10BASE-T1S is present when more than two stations are connected to the bus 40.

Overall, the transmitting/receiving device of the present invention described herein not only can realize communication in the bus system between other stations with the (high) bit rates required for the respective communication standard but is also designed in such a way that the transmittable bit rate is not reduced by errors in the communication.

The transmitting/receiving device of the present invention described herein can be used in particular for gateway products. Such gateway products typically include a voltage supply block and multiple interfaces. For example, a voltage supply U bat is regulated to 5 V in order to operate multiple CAN transmitting/receiving devices (CAN transceivers) and/or LIN transceivers. Such a gateway can contain multiple identical, above-described transmitting/receiving devices, which can then be operated by Tier1 as transmitting/receiving devices for CAN XL (CAN SIC) or 10BASE-T1S by means of control by the controller.

Advantageous further embodiments of the transmitting/receiving device of the present invention are disclosed herein.

The transmitting/receiving device of the present invention may also have a control part for controlling the first to fourth transmission stages, wherein the resistors of the first to fourth transmission stages are each formed from a parallel circuit of up to N switchable resistors, wherein each switchable resistor is connected in series with a switch, where N is a natural number greater than 1, wherein the control part is designed for stepwise control of the switches on the basis of the transmit signal in order to switch the states on the bus due to a change in the state of the transmit signal, and wherein the stepwise control of the switches includes a time-delayed switching on or off of switches of the switches, in which at least two switches of a transmission stage of the first to fourth transmission stages are switched together in one step.

The transmitting/receiving device of the present invention disclosed herein can also have a first terminal for receiving the transmit signal from a communication control device, and a second terminal for outputting the digital receive signal to the communication control device, wherein the at least one module for ascertainment has a COM-IF detection module and is designed to ascertain whether the digital transmit signal at the first terminal has at least one prespecified property of one communication standard of two communication standards for which the transmission module and the reception module are designed for communication in the serial bus system, and wherein the transmitting/receiving device is designed to switch the second terminal as an output or as an input on the basis of an ascertainment result of the COM-IF detection module.

The transmitting/receiving device of the present invention disclosed herein may also have a third terminal for setting one of two prespecified voltage levels, wherein the COM-IF detection module is also designed to ascertain whether the digital transmit signal at the first terminal occurs in combination with one of the two prespecified voltage levels at the third terminal. In this case, in addition or as an alternative to the COM-IF detection module, the at least one module for ascertainment can have a COM-IF determination module, for evaluating-if the transmitting/receiving device is switched to an operating mode in which the transmitting/receiving device can actively carry out communication via at least one of the first to third terminals-whether the third terminal is switched as an output or as an input.

It is possible for the at least one module for ascertainment to comprise a detection module designed to detect the resistance value of a resistor with which the bus is terminated, and the voltage value of a supply voltage applied to the transmitting/receiving device for voltage supply.

The transmitting/receiving device of the present invention disclosed herein may also comprise an operating mode selection module for selecting an operating mode of the transmission module and/or of the reception module on the basis of an output of the at least one module for ascertainment.

For the selection of the operating mode of the transmission module and/or of the reception module, the operating mode selection module may be designed to also evaluate the transmit signal at the first terminal and the voltage level at the third terminal.

The COM-IF detection module may be designed, after passing a detection result to the operating mode selection module, to further evaluate the transmit signal with respect to the at least one prespecified property.

In one example embodiment of the present invention, the transmission module is designed, in one of the two communication standards, to generate the analog differential signals in a first communication phase of the message using a different physical layer than in a second communication phase.

It is possible for the at least two communication standards to have CAN XL and 10BASE-T1S, wherein the communication standard 10BASE-T1S is at least one of the following communication standards, namely 10BASE-T1S multi-drop with a supply voltage of 5 V, 10BASE-T1S multi-drop with a supply voltage of 3.3 V, and 10BASE-T1S single-drop with a supply voltage of 5 V.

The transmitting/receiving device of the present invention may be part of a station for a serial bus system, which also comprises a communication control device for controlling the communication in the serial bus system and for generating the transmit signal, wherein the station is designed for communication in a bus system in which exclusive, collision-free access of a station to the bus of the bus system is ensured at least temporarily.

At least two of the above-described transmitting/receiving devices of the present invention can be part of a gateway for forwarding messages between at least a first bus system and a second bus system, wherein one of the at least two transmitting/receiving devices of the gateway is connected to the first bus system and another of the at least two transmitting/receiving devices is connected to the second bus system.

The aforementioned object may also achieved by a method for communication using differential signals in a serial bus system having certain features of the present invention. The method is performed using a transmitting/receiving device for a station of the bus system, which has a transmission module, a reception module, and at least one module for ascertainment, wherein the single transmission module is designed to transmit a digital transmit signal as an analog differential signal to a bus of the bus system in order to transmit a message to at least one other station of the bus system, wherein the transmission module has a full bridge in which a first and fourth transmission stage are connected in series and a third and second transmission stage are connected in series. According to an example embodiment of the present invention, the method comprises the steps of: ascertaining, using the at least one module for ascertainment, which of at least two communication standards is being used on the bus, setting, in the transmission module, resistance values of resistors of the first to fourth transmission stages on the basis of the ascertainment result of the at least one module for ascertainment, and setting the reception module according to the ascertained communication standard on the bus.

The method of the present invention offers the same advantages as those mentioned above with respect to the transmitting/receiving device of the present invention.

Advantageous further embodiments of the method of the present invention are disclosed herein.

The method of the present invention described above may also include the step of transmitting, using the transmission module, the transmit signal as an analog differential signal to the bus by using the resistors of the first to fourth transmission stages whose resistance values were set in the setting step, and/or the step of receiving, using the reception module, analog differential signals from the bus, for outputting to the communication control device a digital receive signal, which is generated according to the communication standard set in the reception module.

In addition, in the method for communication using differential signals in a serial bus system, the transmitting/receiving device of the present invention described above also performs a method for setting the transmitting/receiving device to one of two communication standards for communication using differential signals in a serial bus system.

Further possible implementations of the present invention also include combinations, even those not explicitly mentioned, of features or embodiments described above or below with respect to the exemplary embodiments. In this case, a person skilled in the art will also add individual aspects as improvements or additions to the relevant basic form of the present invention.

### BRIEF DESCRIPTION OF THE DRAWINGS

The present invention is described in more detail below with reference to the figures and based on exemplary embodiments.

FIG. 1 shows a simplified block diagram of a gateway with bus systems according to a first exemplary embodiment of the present invention.

FIG. 2 shows a diagram for illustrating the structure of a frame for a message which can be transmitted by a station of a bus system according to the first exemplary embodiment of the present invention.

FIG. 3 shows a block diagram of a transmitting/receiving device of a station of the bus system in FIG. 1, according to an example embodiment of the present invention.

FIG. 4 shows a block diagram of the transmitting/receiving device in FIG. 3 when the transmitting/receiving device is set for a first communication standard for differential signals on the bus with the frame according to FIG. 2.

FIG. 5 shows a block diagram of the transmitting/receiving device in FIG. 3 when the transmitting/receiving device is set for a second communication standard for differential signals on the bus.

FIGS. 6 to 9 show an example of a time curve of signals that are received by the transmitting/receiving device in the configuration in FIG. 4 for a frame in FIG. 2 or are generated on the bus.

FIG. 10 shows another example of a time curve of signals (TxD or RxD) that are received by the transmitting/receiving device in the configuration in FIG. 4 in an arbitration phase (SIC operating mode) or are generated on the bus.

FIG. 11 shows the time curve of the bus signals CAN_H, CAN_L that are transmitted to the bus by the transmitting/receiving device in FIG. 4 on the basis of the transmit signal in FIG. 10.

FIGS. 12 to 15 show an example of a time curve of signals that are received by the transmitting/receiving device in the configuration in FIG. 5 or are generated on the bus.

FIG. 16 shows the time curve of a reset signal that is received by the transmitting/receiving device in the configuration in FIG. 5.

FIG. 17 shows a circuit diagram of a transmission module for a transmitting/receiving device, which transmission module can be used for a station of the bus system according to the first exemplary embodiment of the present invention.

FIG. 18 is a diagram illustrating the calculation of H-bridge resistances of the transmission module in FIG. 17, according to an example embodiment of the present invention.

FIG. 19 shows a block diagram of a control part of the transmission module in FIG. 17.

FIG. 20 shows a time curve of a signal state transition which can be generated using the transmission module in FIG. 17, according to an example embodiment of the present invention.

FIG. 21 shows an electrical circuit diagram of a part of a logic block of the control part in FIG. 19 and of a resistor array for a transmission stage of the transmission module in FIG. 17, according to an example embodiment of the present invention.

In the figures, identical or functionally identical elements are given the same reference signs unless otherwise indicated.

### DETAILED DESCRIPTION OF EXAMPLE EMBODIMENTS

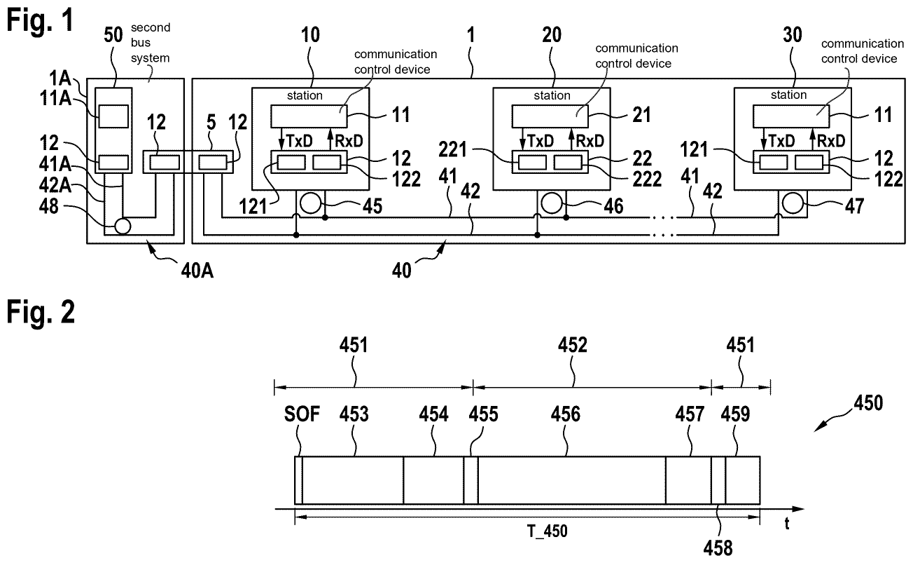

FIG. 1 shows a first bus system 1 and a second bus system 1A, which are connected to each other via a gateway 5. However, the gateway 5 can be connected to more than two bus systems 1, 1A, even though this is not shown in the figures.

The first bus system 1 can, for example, at least in portions be a CAN bus system, such as a Classical CAN bus system, a CAN FD bus system, a CAN XL bus system, etc., according to the international standard ISO 11898-1:2024. The second bus system 1A can, for example, at least in portions be a 10BASE-T1S bus system according to the international standard IEEE 802.3cg™. However, bus systems 1 and 1A are not limited to this. In particular, the bus systems 1, 1A can be designed to operate according to the same communication standard. The bus systems 1, 1A can be used in a vehicle, in particular a motor vehicle, an aircraft, etc., or in a hospital, etc.

Although the bus systems 1, 1A are described below using CAN bus systems and 10BASE-T1S bus systems, none of the bus systems 1, 1A are limited to these. Alternatively, at least one of the bus systems 1, 1A can be another serial bus system 1 that uses differential signals in particular.

In FIG. 1, the bus system 1 has a plurality of stations 10, 20, 30, which, like the gateway 5, are each connected to a bus 40 or bus line having a first bus wire 41 and a second bus wire 42. In a CAN bus system, the bus wires 41, 42 can also be called CANH and CANL for carrying signals CAN_H, CAN_L on the bus 40. The bus wires 41, 42 together form the bus line for the bus 40.

In the example in FIG. 1, the bus system 1A has a station 50 which, like the gateway 5, is connected to a bus 40A or bus line having a first bus wire 41A and a second bus wire 42A. In a 10BASE-T1S bus system 1A, the bus wires 41A, 42B are called LINE+ and LINE−. The bus wires 41A, 42B together form the bus line for the bus 40A. The maximum net data transmission rate in a 10BASE-T1S bus system 1A is 10 megabits per second.

Messages 45, 46, 47 in the form of signals are transmitted between the individual stations 10, 20, 30 and the gateway 5 via the first bus 40. Messages 48 in the form of signals can be transmitted between the station 50 and the gateway 5 via the second bus 40A. The gateway 5 can forward the messages 45, 46, 47, in each case converted into the required communication standard, to the bus 40A and/or forward a message 48 to the bus 40. The stations 10, 20, 30, 50 are, for example, control devices or display devices of a motor vehicle.

As shown in FIG. 1, the stations 10, 30 each have a communication control device 11 and a transmitting/receiving device 12. The transmitting/receiving device 12 has a transmission module 121 and a reception module 122.

The station 20 has a communication control device 21 and a transmitting/receiving device 22. The transmitting/receiving device 22 has a transmission module 221 and a reception module 222.

The station 50 has a communication control device 11A and a transmitting/receiving device 12. The transmitting/receiving device 12 also has a transmitting module 121 and a receiving module 122, although this is not shown in FIG. 1.

The transmitting/receiving devices 12 of the stations 10, 30 and the transmitting/receiving device 22 of the station 20 are each directly connected to the bus 40, even though this is not shown in FIG. 1. The same applies to the transmitting/receiving device 12 of the station 50 with respect to the bus 40A.

The communication control devices 11, 21 are each used for controlling communication of the corresponding station 10, 20, 30 via the bus 40 with at least one other station of the stations 10, 20, 30 which are connected to the bus 40. The same applies to the communication control device 11A of the station 50 with respect to the bus 40A.

The communication control device 11 creates and reads first messages 45, 47, which are, for example, modified CAN messages 45, 47. Here, the modified CAN messages 45, 47 are constructed on the basis of the CAN XL format, for example. The transmitting/receiving device 12 serves for transmitting and receiving the messages 45, 47 from the bus 40. The transmission module 121 receives a digital transmit signal TxD generated by the communication control device 11 for one of the messages 45, 47 and converts said transmit signal into signals on the bus 40. The digital transmit signal TxD can be a pulse-width-modulated signal, at least temporarily or in sections. The reception module 122 receives signals transmitted on the bus 40, according to the messages 45 to 47, and generates a digital receive signal RxD therefrom. The receiving module 122 transmits the receive signal RxD to the communication control device 11.

In addition, the communication control device 11 can be designed to create and read second messages 46, which are, for example, CAN FD messages 46. The transmitting/receiving device 12 can be designed accordingly.

The communication control device 11A is described in more detail with reference to FIG. 5.

The communication control device 21 in FIG. 1 may be designed as a conventional CAN controller according to ISO 11898-1:2015, i.e. as a CAN FD-tolerant Classical CAN controller or a CAN FD controller. The communication control device 21 creates and reads second messages 46, for example CAN FD messages or Classical CAN messages. The transmitting/receiving device 22 is used to transmit and receive the messages 46 to/from the bus 40. The transmission module 221 receives a digital transmit signal TxD generated by the communication control device 21 and converts said transmit signal into signals for a message 46 on the bus 40. The reception module 222 receives signals transmitted on the bus 40, corresponding to the messages 45 to 47, and generates a digital receive signal RxD therefrom. The transmitting/receiving device 22 may be designed as a conventional CAN FD transceiver or CAN SIC transceiver.

For transmitting the messages 45, 46, 47 with CAN SIC or CAN XL to the bus 40, proven properties are adopted that are responsible for the robustness and user-friendliness of CAN and CAN FD, in particular the frame structure with identifier and arbitration according to the conventional CSMA/CR method. The CSMA/CR method has the consequence that there must be so-called recessive states on the bus 40, which can be overwritten by other stations 10, 20, 30 with dominant levels or dominant states on the bus 40.

The two stations 10, 30 can be used to form and then transmit messages 45, 47 with different CAN formats, in particular the Classical CAN format or the CAN FD format or the CAN XL format, as well as to receive such messages 45, 47. This is described in more detail below for a message 45.

If no communication takes place on the bus 40, at least one of the stations 10, 20, 30, in particular its communication control device 11, 21, can be put into a sleep mode SLEEP. This can save energy.

In CAN XL, the station 10, 30 in particular switches its transmitting/receiving device 12 to an operating mode SLOW or SIC in order to participate in the communication on the bus 40. In the operating mode SLOW or SIC, the station 10, 30 can participate in an arbitration between the stations 10, 20, 30 of the bus system 1 in an arbitration phase 451 (first communication phase) of a frame in FIG. 2.

FIG. 2 shows, for the message 45, a frame 450, which is in particular a CAN XL frame, said frame being provided by the communication control device 11 for the transmitting/receiving device 12 for transmission to the bus 40. In this case, the communication control device 11 creates the frame 450 as compatible with CAN FD in the present exemplary embodiment. Alternatively, the frame 450 is compatible with any successor standard for CAN FD. The frame 450 has a maximum duration T_450, which corresponds to a prespecified maximum frame length of the frame 450.

According to FIG. 2, the frame 450 is divided, for CAN communication on the bus 40, into different communication phases 451, 452, namely an arbitration phase 451 (first communication phase) and a data phase 452 (second communication phase). After a start bit SOF, the frame 450 has an arbitration field 453, a control field 454, a first switching field 455, a data field 456, a checksum field 457, a second switching field 458 and a frame termination field 459. The checksum field 457, the second switching field 458 and the frame termination field 459 form a frame end phase 457, 458, 459 of the frame 450.

In the arbitration phase 451, with the aid of an identifier (ID) in the arbitration field 453, negotiation takes place bitwise between the stations 10, 20, 30 as to which station 10, 20, 30 wishes to transmit the message 45, 46 with the highest priority and will therefore receive exclusive access to the bus 40 of the bus system 1 for the near future for transmitting in the subsequent data phase 452. A physical layer such as in CAN or CAN FD or CAN SIC is used in the arbitration phase 451. The physical layer corresponds to the bit transmission layer or layer 1 of the conventional OSI model (Open Systems Interconnection model).

During the phase 451, the conventional CSMA/CR method is used, which allows simultaneous access of the stations 10, 20, 30 to the bus 40 without the higher priority message 45, 46 being destroyed. As a result, further bus stations 10, 20, 30 can be added relatively easily to the bus system 1, which is very advantageous.

The CSMA/CR method has the consequence that there must be so-called recessive states on the bus 40, which can be overwritten by other stations 10, 20, 30 with dominant levels or dominant states on the bus 40. In the recessive state, high-impedance conditions prevail at the individual station 10, 20, 30, which in combination with the parasites on the bus circuit results in longer time constants. This leads to a limitation of the maximum bit rate of the present-day CAN FD physical layer to currently about 2 megabits per second in real vehicle use.

At the end of the arbitration phase 451, the first switching field 455 is used to switch to the operating mode for the data phase 452. In the case of CAN XL, the station 10, 30, in particular its transmitting/receiving device 12, which has won the arbitration and is therefore the transmitter of the frame 450 in the data phase 452, switches to an operating mode FAST_TX. However, in the case of CAN XL, the station 10, 30, in particular its transmitting/receiving device 12, which has lost the arbitration and is therefore only a receiver of the frame 450 in the data phase, switches to an operating mode FAST_RX.

In the data phase 452, in addition to a portion of the first switching field 455, the payload data of the CAN XL frame 450 or of the message 45 from the data field 456 are transmitted, and so is the checksum field 457 and a portion of the second switching field 458. At the end of the data phase 452, the second switching field 458 is used to switch back to the arbitration phase 451.

A transmitter of the message 45 begins to transmit bits of the data phase 452 to the bus 40 only when the station 10 as the transmitter has won the arbitration and the station 10 as the transmitter thus has exclusive access to the bus 40 of the bus system 1 for transmitting.

Thus, in the arbitration phase 451 as the first communication phase, the stations 10, 30 use, in part, in particular up to the FDF bit (inclusive), a format from CAN/CAN FD, according to ISO11898-1:2015. However, in comparison with CAN or CAN FD, an increase in the net data transmission rate to more than 10 megabits per second, in particular 20 Mbit/s, is possible in the data phase 452 as the second communication phase. In addition, an increase in the size of the payload data per frame, in particular to about 2 kilobytes or any other value, is possible.

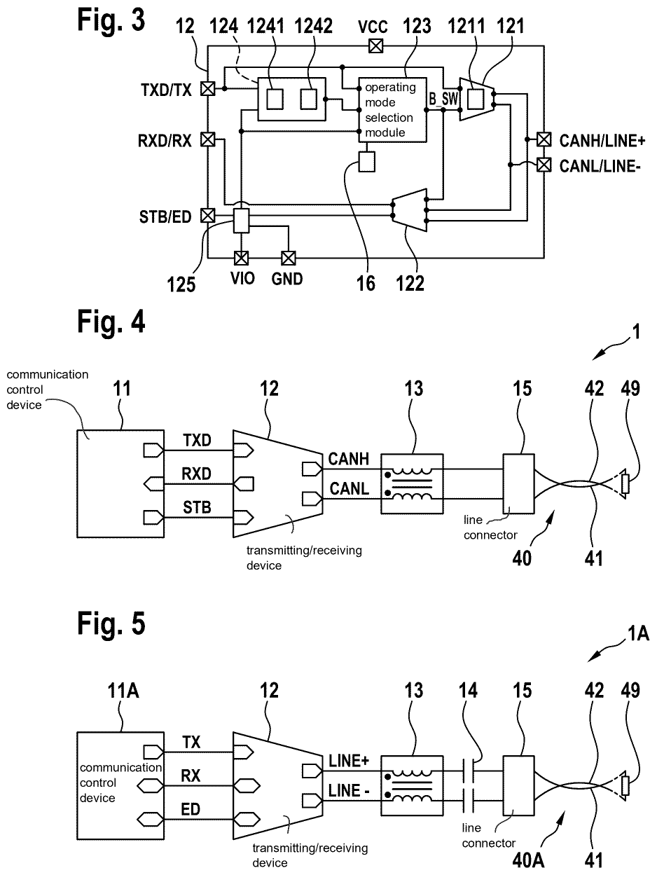

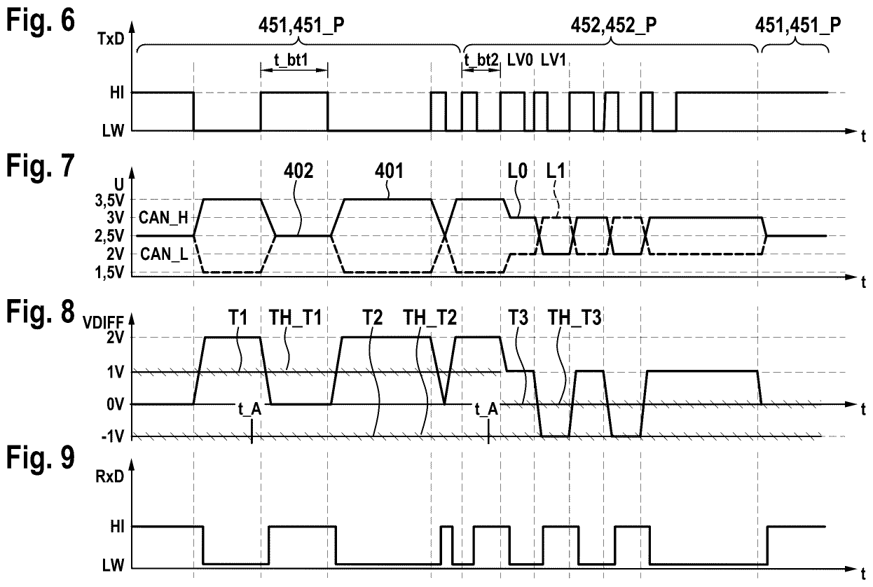

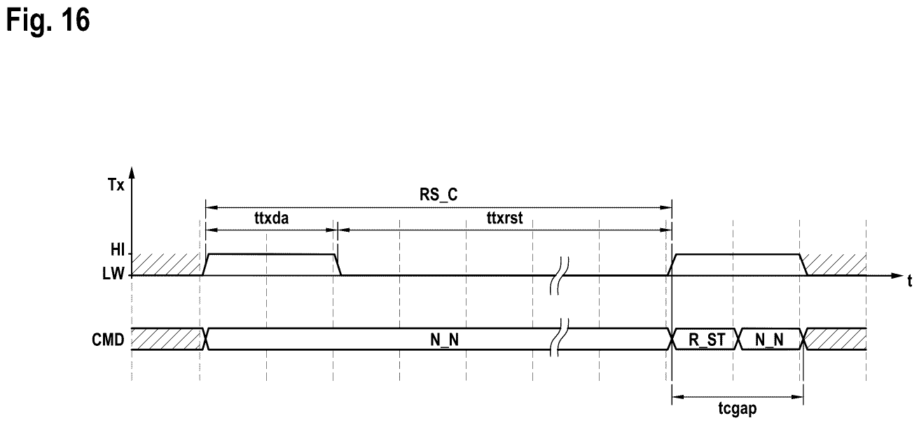

FIG. 3 shows in more detail the transmitting/receiving device 12 which can be used for one of the stations 10, 30. The transmitting/receiving device 12 has a terminal TXD/TX for a transmit signal in FIG. 6 or FIG. 10 or FIG. 12 or the reset signal in FIG. 16, a terminal RXD/RX for a receive signal in FIG. 9 or FIG. 15, a STB/ED terminal for, in particular, a status signal, a terminal CANH/LINE+ for the signal CAN_H or LINE+, and a terminal CANL/LINE− for the signal CAN_L or LINE−. Additionally, the transmitting/receiving device 12 has terminals for a voltage supply VCC, ground (GND) and VIO for an optional other voltage supply of the terminals TXD/TX, RXD/RX, STB/ED. However, the number of terminals of the transmitting/receiving device 12 is not limited to the stated number of 8 terminals. Instead, the number of terminals can be chosen as needed.

The transmitting/receiving device 12 also has the transmission module 121, the reception module 122, and an operating mode selection module 123. In addition, the transmitting/receiving device 12 in FIG. 3 has a communication interface detection module 124 and/or a communication interface determination module 125 and a communication interface detection module 16. Each of the modules 124, 125, 16 is a module for ascertainment, in particular by detecting or evaluating or determining which of at least two communication standards, in particular CAN or 10BASE-T1S, is to be used and/or is being used on the bus 40 or 40A.

The communication interface detection module 124 is hereinafter referred to as the COM-IF detection module 124. The communication interface determination module 125 can also be referred to as the COM-IF determination module 125. As described below, the detection module 124 detects which of at least two communication standards, in particular CAN or 10BASE-T1S, is to be used and/or is being used on the bus 40 or 40A.

The COM-IF detection module 124 has a check block 1241 for checking the state of the terminals TXD/TX, STB/ED and/or of a signal at the respective terminal TXD/TX, STB/ED. In addition, the COM-IF detection module 124 has a decision block 1242 for deciding which communication control device 11, 11A is connected to the transmitting/receiving device 12. The COM-IF detection module 124 thus performs an evaluation of the state, in particular voltage level or resistance value, of the terminals TXD/TX, STB/ED and/or of a signal at the respective terminal TXD/TX, STB/ED. This is described in more detail below.

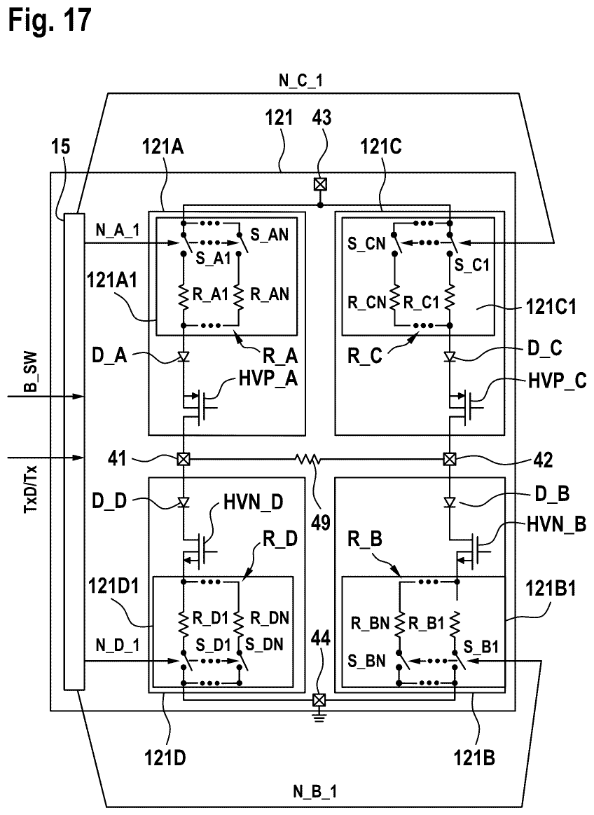

The transmission module 121 in FIG. 3 is designed as a full bridge with four transmission stages, as described in more detail below with reference to FIGS. 17 to 20. The transmission module 121 has an internal resistor 1211.

The transmitting/receiving device 22 can be constructed in the same way as the transmitting/receiving device 12. For this reason, the transmitting/receiving device 22 is not described separately.

In the transmitting/receiving device 12 in FIG. 3, the voltage supply for supplying electrical energy to the first and second bus wires 41, 42 is effected via the at least one terminal VCC. In particular, a voltage of 5 V or 3.3 V or any other desired electrical voltage for the voltage supply can be connected to the terminal VCC. The connection to ground, in particular CAN_GND, is realized via the terminal GND.

The communication interface detection module 16 is designed to ascertain, in particular to detect and/or evaluate, the electrical properties of the bus system 1 and/or of the bus system 1A in FIG. 1. In particular, the module 16 in FIG. 3 detects the resistance value of a resistor 49 according to FIG. 4 or FIG. 5 with which the bus 40 or 40A is terminated. In addition, the module 16 can detect the voltage value of a supply voltage at the designated terminal VCC of the transmitting/receiving device 12 for the voltage supply. To simplify the illustration, the exact wiring of the communication interface detection module 16 is not shown in FIG. 3. The communication interface detection module 16 outputs its ascertainment result, in particular detection result, to the operating mode selection module 123. The detection module 16 thus detects which of at least two communication standards CAN or 10BASE-T1S is being used on the bus 40 or 40A. The COM-IF detection module 124 outputs its ascertainment result, in particular detection result and/or evaluation result, to the operating mode selection module 123.

Even though both communication interface detection modules 124, 16 are present in the present exemplary embodiment, this is not absolutely necessary. Depending on the conditions on the bus 40, 40A, for example if more than two stations 10, 20, 30, 50 are always connected to the bus 40, 40A and/or it is clear which supply voltage VCC is used for the transmitting/receiving device 12, the communication interface detection module 16 can be omitted, for example.

As shown in FIG. 3, the transmitting/receiving device 12 can be connected with the terminals CANH/LINE+ and CANL/LINE− to the bus 40, more precisely its first bus wire 41 for CAN_H or CAN XL_H or LINE+ and its second bus wire 42 for CAN_L or CAN XL_L or LINE−. More precisely, the transmission module 121 is connected at its output to the terminals CANH/LINE+ and CANL/LINE−. In addition, the reception module 122 is connected at its input to the terminals CANH/LINE+ and CANL/LINE−.

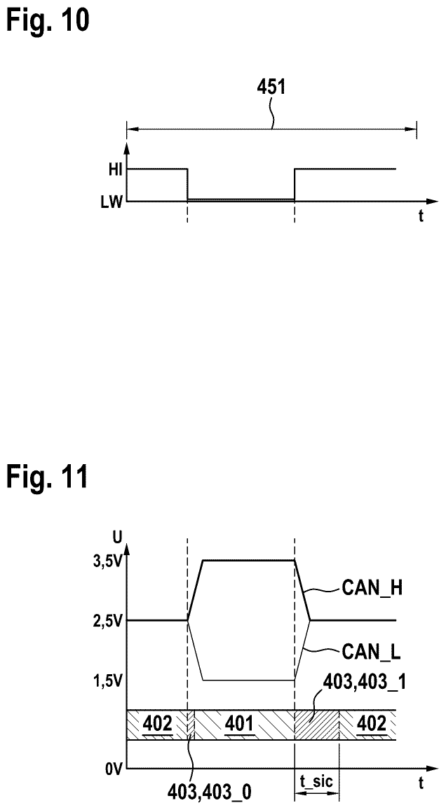

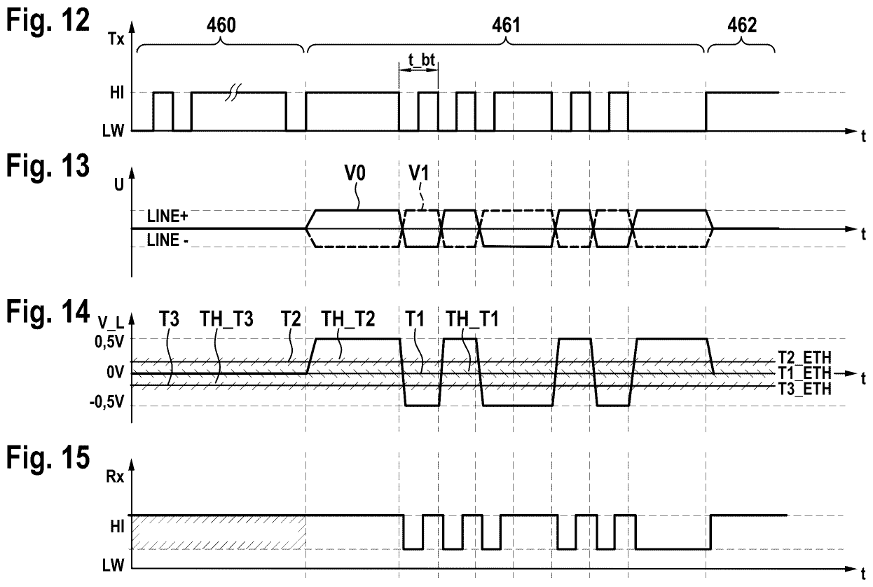

The transmission module 121 in FIG. 3 is connected at its input to the terminal TXD/TX for receiving a transmit signal TxD (shown in FIG. 6 or FIG. 10) from the communication control device 11 in FIG. 1 or for receiving a transmit signal Tx shown in FIG. 12 or FIG. 16. In addition, the transmission module 121 is connected at its input to an output of the operating mode selection module 123 at which an operating mode selection signal B_SW with information for selecting the operating mode to be switched is output.

In addition, the reception module 122 in FIG. 3 is connected at its input to the output of the operating mode selection module 123 at which the operating mode switching signal B_SW is output. A first output of the reception module 122 is connected to the terminal RXD/RX for outputting a receive signal RxD (shown in FIG. 9) to the communication control device 11 in FIG. 1 or for outputting a receive signal Rx as shown in FIG. 15. A second output of the reception module 122 is connected to the terminal STB/ED.

The operating mode selection module 123 in FIG. 3 is connected at a first input terminal to the terminal TXD/TX for receiving the transmit signal TxD or Tx, as described above. In addition, the operating mode selection module 123 in FIG. 3 is connected at a second input terminal to the output of the COM-IF detection module 124. In addition, the operating mode selection module 123 in FIG. 3 is connected at a third input terminal to the terminal STB/ED. And, the operating mode selection module 123 in FIG. 3 is connected at a fourth input terminal to the output of the detection module 16. The output terminal of the operating mode selection module 123 is connected to the transmission module 121 and to the reception module 122, as described above.

The COM-IF detection module 124 in FIG. 3 is connected at its first input terminal to the terminal TXD/TX for receiving the transmit signal TxD or Tx, as described above. In addition, the COM-IF detection module 124 in FIG. 3 is connected at its second input terminal to the terminal STB/ED.

The COM-IF detection module 124 thus evaluates the input at the terminals TXD/TX, STB/ED in order to determine whether the transmitting/receiving device 12 is connected to a communication control device 11 (CAN XL controller) or to a communication control device 11A (10BASE-T1S controller) in FIG. 5. The COM-IF detection module 124 outputs its evaluation result to the operating mode selection module 123.

The COM-IF detection module 124 can be a digital component, which is in particular a discrete-time system. The COM-IF detection module 124 can be operated at a prespecified frequency, which is suitable for checking the signal at the terminal TXD/TX. In particular, the frequency is greater than 400 MHz.

If the COM-IF detection module 124 is present, the operating mode selection module 123 in FIG. 3 is designed to determine the current operating mode from the inputs at the terminal TXD/TX and the output of the module 124, namely, for example, SLEEP, SLOW or SIC, FAST_TX, FAST_RX for CAN XL or LOW_POWER, NORMAL, TRANSMITTING, CONFIG for 10BASE-T1S.

If the COM-IF determination module 125 is additionally or alternatively present, the operating mode selection module 123 in FIG. 3 is designed to select and/or determine the current operating mode from the output of the module 125, namely, for example, SLEEP, SLOW or SIC, FAST_TX, FAST_RX for CAN XL or LOW_POWER, NORMAL, TRANSMITTING, CONFIG for 10BASE-T1S.

The COM-IF determination module 125 is designed to evaluate the state of the terminal STB/ED when the transmitting/receiving device 12 is active, i.e. when the transmitting/receiving device 12 is not switched to a passive state. For example, active states for CAN XL are the operating modes SLOW or SIC, FAST_TX, FAST_RX and active states for 10BASE-T1S are the operating modes NORMAL, TRANSMITTING, CONFIG.

If the COM-IF determination module 125 detects that the terminal STB/ED is pulled to the state LW (LOW) from the outside without the state handling for the operating mode CONFIG for 10BASE-T1S having been completed beforehand, the transmitting/receiving device 12 will behave according to the CAN standard, in particular the CAN XL standard (CiA610-3), and will enter or remain in the active state of CAN, in particular CAN XL. The reason for this is that such a state at the terminal STB/ED necessarily indicates that the transmitting/receiving device 12 is connected to a communication control device 11, in particular a CAN or CAN XL controller.

If the COM-IF determination module 125 detects that the terminal STB/ED is pulled to the state LW (LOW) from the outside, wherein the state handling for the operating mode CONFIG for 10BASE-T1S has been completed beforehand, the transmitting/receiving device 12 will behave according to the standard 10BASE-TIS for the function according to Open Alliance TC14 and enter the active state for the operating mode CONFIG. The behavior according to the 10BASE-T1S standard is described in more detail with reference to FIG. 5.

The COM-IF determination module 125 in FIG. 3 can, for example, be designed as analog hardware for the distinction between the two communication standards CAN, in particular CAN XL, and 10BASE-T1S. Such hardware is available for this distinction not only in CAN, since the STB terminal is switched as an input, but also in 10Base-T1S for the detection of the operating mode CONFIG. This means that no significant additional circuitry outlay is required to distinguish between these two communication standards.

In addition, the COM-IF determination module 125 can use a comparator (not shown) to evaluate the state of the terminal STB/ED when the transmitting/receiving device 12 is passive. In such a passive state of the transmitting/receiving device 12, the transmitting/receiving device 12 is, for example, switched to the operating mode STANDBY for CAN, in particular CAN XL, and to the operating mode LOW_POWER for 10BASE-T1S.

Furthermore, the operating mode selection module 123 is designed to forward its determination result, i.e. the information about the operating mode, to the modules 121, 122 in the signal B_SW. In particular, the operating mode selection module 123 uses the signal B_SW to switch the operating mode of the transmission module 121 and the operating mode of the reception module 122 according to the required communication standard for which the transmitting/receiving device 12 is to be used. This is described below with reference to FIG. 4 in relation to a CAN bus system 1 and with reference to FIG. 5 in relation to a 10BASE-T1S bus system 1A.

FIG. 4 shows that the transmitting/receiving device 12 in a CAN bus system 1 for communication according to the CAN XL standard is connected between the communication control device 11 in FIG. 1 and a DC choke 13. The DC choke 13 is connected via a line connector 15 to the bus wires 41, 42 of the bus line for the bus 40. The DC choke 13 is also called common-mode choke (CMC). The bus wires 41, 42 can be designed as twisted wires. The twisted wires are also referred to as a twisted pair. The first and second bus wires 41, 42 are terminated with a terminating resistor 49. The terminating resistor 49 is an external load resistor for the transmission module 121. As mentioned above, the transmission module 121 can be designed as a full bridge with four transmission stages. The resistor 49 is connected in the bridge branch of the full bridge between the terminals CANH/LINE+ and CANL/LINE− of the transmitting/receiving device 12, more precisely of the transmission module 121, for the bus wires 41, 42.

FIG. 5 shows that the transmitting/receiving device 12 in a 10BASE-T1S bus system 1A for communication according to the standard 10BASE-T1S is connected between the communication control device 11A and the DC choke 13. The DC choke 13 is connected to the line connector 15 and thus to the bus wires 41, 42 and the terminating resistor 49 via an AC decoupling module 14, in particular at least one decoupling capacitor. For this purpose, decoupling capacitors with a capacitance of 100 nF are used in 10BASE-T1S for both operating modes multi-drop and single-drop. The communication control device 11A is designed to control communication according to the standard 10BASE-T1S. The AC voltage decoupling module 14 can also be called an AC decoupling module. Otherwise, the same applies to the transmission module 121 as described with reference to FIG. 3 and/or FIG. 4.

As shown in FIG. 4 and FIG. 5, the terminal RXD/RX and the terminal STB/ED of the transmitting/receiving device (transceiver) 12 can be switched differently for use in the bus systems 1, 1A.

The following Table 1 shows an example of the types and functions of the individual terminals (SO8 terminal or SO8 pin) of the transmitting/receiving device 12.

TABLE 1
Comparison of the type and function of the terminals of the
transmitting/receiving device 12 for CAN XL and 10BASE-T1S

| | 10BASE-T1S | | 10BASE-T1S | | 10BASE-T1S |
|---|---|---|---|---|---|
| CAN XL | SO8 pin | CAN XL | SO8 pin | CAN XL | SO8 pin |
| SO8 pin | (Oa3p pin) | SO8 pin | (OA3p pin) | SO8 pin | (Oa3p pin) |
| name | name | type | type | function | function |
| CANH | LINE+ | Output/ | Output/ | Bus line | Bus line |
| | | input | input | positive | positive |
| CANL | LINE− | Output/ | Output/ | Bus line | Bus line |
| | | input | input | negative | negative |
| TXD | TX | Input | Input | Transceiver | Transceiver |
| | | | | input state | input state |
| | | | | control | control |
| RXD | RX | Output | Output/ | Receiver | Receiver |
| | | | input | output | output |
| | | | | wake-up | wake-up |
| | | | | signaling | signaling |
| | | | | | CONFIG mode: |
| | | | | | MDIO clock |
| | | | | | input |
| VCC | VCC | Input | Input | Voltage | Voltage |
| | | | | supply | supply |
| VIO | VIO | Input | Input | Voltage | Voltage |
| | | | | supply I/O | supply I/O |
| GND | GND | Input | Input | Ground | Ground |
| STB | ED | Input | Output/ | Standby | Collision |
| | | | input | on/off | detection |
| | | | | | activity |
| | | | | | detection |
| | | | | | Config. |
| | | | | | operating |
| | | | | | mode: MDIO |
| | | | | | data input |

If the transmitting/receiving device 12 is switched to the configuration in FIG. 4, the signals in FIG. 6 to FIG. 11 are received or generated at the terminals of the transmitting/receiving device 12. The transmitting/receiving device 12 can be switched to different operating modes SLEEP, SLOW or SIC, FAST_TX, FAST_RX, as specified in the international standard ISO 11898-1:2024 for CAN.

FIG. 6 shows an example of a time curve of a digital transmit signal TxD, which the transmitting/receiving device 12 receives serially from the communication control device 11 for a frame 450 in FIG. 2. The transmit signal TxD is divided over time t into the two communication phases 451, 452, as described above.

In the first communication phase (arbitration phase) 451, the transmit signal TxD has bits with a bit time t_bt1 and the two different states HI (high), in particular 1, and LW (low), in particular 0. In the second communication phase (data phase) 452, the transmit signal TxD is at least temporarily a pulse-width-modulated signal with a bit time t_bt2 and the two different states LV0, LV1, which are also called PWM symbols. The bit time t_bt2 is shorter than the bit time t_bt1.

According to FIG. 6, the transmitting/receiving device 12, as well as the transmitting/receiving device 22, uses a first physical layer 451_P in the first communication phase (arbitration phase) 451 to transmit to the bus 40 the transmit signal TxD in FIG. 6 as differential bus signals CAN_H, CAN_L according to FIG. 7. For the physical layer 451_P, there is the operating mode SLOW or SIC of the transmitting/receiving device 12, as described in more detail above and below.

However, in the second communication phase (data phase) 452, the transmitting/receiving device 12 according to FIG. 6 can use a second physical layer 452_P, which differs from the first physical layer 451_P, to transmit to the bus 40 the transmit signal TxD in FIG. 6 as differential bus signals CAN_H, CAN_L according to FIG. 7. There are two operating modes of the transmitting/receiving device 12, namely, FAST_TX and FAST RX, for the physical layer 452_P, as described above in more detail.

As shown in FIG. 7, the signals CAN_H, CAN_L are serial analog signals and have alternately at least one dominant state 401 or at least one recessive state 402. In the dominant state 401, U=VCAN_H=3.5 V and U=VCAN_L=1.5 V. In the recessive state 402, U=VCAN_H=VCAN_L=2.5 V. A dominant state 401 (dom) is driven in the phase 451 during NRZ encoding of the transmit signal TxD when TXD=0 or LW (LOW). A recessive state 402 (rec) is generated or occurs during NRZ encoding of the transmit signal TxD in the phase 451 when TXD=1 or HI (HIGH).

After the arbitration in the arbitration phase 451, one of the stations 10, 20, 30 is determined to be the winner. If the particular station 10, 30 detects the signaling in the first switching field 455 in FIG. 2 for switching from the first to the second communication phase 451, 452, the associated transmitting/receiving device 12 switches its physical layer 451_P at the end of the arbitration phase 451 to the physical layer 452_P of the data phase 452, as described above.

As shown in FIG. 7, in the data phase 452 or in the second operating mode (FAST_TX), the transmission module 121 of the transmitter then, depending on a transmit signal TxD in FIG. 6, generates the states L0 or L1 one after the other and therefore serially using the physical layer 452_P for the signals CAN_H, CAN_L on the bus 40. The state L0 (VCAN_H=3.0 V, VCAN_L=2.0 V) is driven during a pulse width modulation (PWM encoding) of the transmit signal TxD for a first PWM symbol in the transmit signal TxD. The state L1 (VCAN_H=2.0 V and VCAN_L=3.0 V) is driven in the transmit signal TxD during the pulse width modulation (PWM encoding) of the transmit signal TxD for a second PWM symbol LV1, which is different from the first PWM symbol LV0.

The frequency of the signals CAN_H, CAN_L can be increased according to the transmit signal TxD in the data phase 452. For this purpose, in the example in FIG. 6 and FIG. 7, the bit time or bit duration t_bt2 in the data phase 452 is shorter or less than the bit time or bit duration t_bt1 in the arbitration phase 451. In the example in FIG. 6 and FIG. 7, the net data transmission rate in the data phase 452 is therefore increased compared to the arbitration phase 451.

In contrast, for example, the transmitting/receiving device 12 of the station 30 switches its physical layer 451_P at the end of the arbitration phase 451 from the first operating mode (SLOW or SIC) to the physical layer 452_P of the data phase 452 for the third operating mode (FAST_RX) of the transmitting/receiving device 12 when the station 30 is only a receiver, i.e. not a transmitter, of the frame 450 in the data phase 452.

If the transmitting/receiving device 12, in particular with the signaling in the second switching field 458 in FIG. 2, detects that a switchover from the data phase 452 back to the arbitration phase 451 is to be made, the transmitting/receiving device 12 will be switched from transmitting (operating mode FAST_TX) (and) or receiving (operating mode FAST_RX) signals with the physical layer 452_P to transmitting and/or receiving signals with the physical layer 451_P. Thus, after the end of the data phase 452 all transmitting/receiving devices 12 switch their operating mode to the first operating mode (SLOW or SiC). All transmitting/receiving devices 12 can thus not only switch between the bit times t_bt1, t_bt2 but also switch their physical layer, as described above.

According to FIG. 8, in the arbitration phase 451, in the ideal case, a difference signal VDIFF=CAN_H−CAN_L with values of VDIFF=2 V for dominant states 401 (dom) and VDIFF=0 V for recessive states 402 (rec) is formed over time t on the bus 40.

The curve of VDIFF in the phase 451 is shown on the left-hand side in FIG. 8. In contrast, in the data phase 452, a difference signal VDIFF=CAN_H−CAN_L corresponding to the states L0, L1 in FIG. 7 is formed over time t on the bus 40, as shown on the right-hand side in FIG. 8. The state L0 has a value VDIFF=1V. The state L1 has a value VDIFF=−1V.

The reception module 122 can distinguish the states 401, 402 with, in each case, two of the reception thresholds T1, T2, T3, which lie in the ranges TH_T1, TH_T2, TH_T3. For this purpose, the reception module 122 evaluates the signals in FIG. 7 or FIG. 8 at times t A, as shown in FIG. 8. For evaluating the signals in FIG. 7 or FIG. 8, in the arbitration phase 451, the reception module 122 uses the reception threshold T1 of, for example, 0.7 V and the reception threshold T2 of, for example, −0.35 V. In contrast, in the data phase 452, the reception module 122 only evaluates signals with the reception threshold T3. When switching between the first to third operating modes (SLOW or SIC, FAST_TX, FAST_RX) described above with reference to FIG. 6, the reception module 122 switches the reception thresholds T2, T3 in each case.

The reception threshold T2 is used to detect whether the bus 40 is free when the station 12 is newly connected to the communication on the bus 40 and attempts to integrate itself into the communication on the bus 40.

When receiving the corresponding signals from the bus 40, each transmitting/receiving device 12 generates the associated receive signal RxD, as shown in FIG. 9. Ideally, the receive signal RxD in FIG. 9 has no time offset from the transmit signal TxD in FIG. 6.

FIG. 10 shows an example of a portion of the digital transmit signal TxD, which the transmission module 121 receives in the arbitration phase 451 from the communication control device 11 and from which said transmission module generates the signals CAN_H, CAN_L for the bus 40. In FIG. 10, the transmit signal TxD switches from a state LW (low) to a state HI (high) and back to the state LW (low).

As shown in more detail in FIG. 11, for the transmit signal TxD in FIG. 10, the transmission module 121 generates the signals CAN_H, CAN_L for the bus wires 41, 42 in such a way that a state 403 (sic) is additionally present. The state 403 (SIC) can have different lengths, as shown with the state 403_0 (SIC) during the transition from the state 402 (rec) to the state 401 (dom) and with the state 403_1 (sic) during the transition from the state 401 (dom) to the state 402 (rec). The state 403_0 (sic) is shorter in time than the state 403_1 (sic). In order to generate signals according to FIG. 11, the transmission module 121 is switched to a SIC operating mode (SIC mode).

Passing through the short sic state 403_0 is not required in CiA610-3 and the state depends on the type of implementation. The duration of the “long” state 403_1 (sic) is specified for CAN SIC as well as for the SIC operating mode in CAN XL as t sic<530 ns, starting with the rising edge of the transmit signal TxD in FIG. 10.

In the “long” state 403_1 (SIC), the transmission module 121 should adapt the impedance between the bus wires 41 (CANH) and 42 (CANL) as well as possible to the wave impedance Zw of the bus line used. Here, Zw equals 100 ohms or 120 ohms. This adaptation prevents reflections and thus allows operation at higher bit rates. For the sake of simplicity, hereinafter reference will always be made to the state 403 (sic) or sic state 403.

With a configuration of the transmitting/receiving device 12 according to FIG. 4, the transmission module 121 can be used to generate signals for the bus 40 for the following CAN types: CAN FD, CAN SIC, and CAN XL, as shown in Table 2 below.

TABLE 2
CAN types for transmission module 121

| | Communication phases/ | | Transmission |
|---|---|---|---|
| CAN type | bit rate | Bus states | module states |
| CAN FD | Arbitration | dom, rec | dom, rec |
| CAN SIC | Arbitration | dom, sic, rec | dom, sic, rec |
| CAN XL | Arbitration or | dom, sic, rec | dom, sic, rec |
| | arbitration and data | | |
| | field for the case in | | |
| | which no switching to | | |
| | one of the FAST | | |
| | operating modes occurs | | |
| CAN XL | Data phase | L0, L1 | L0, L1 |

Thus, the transmitting module state 403 (sic) can be generated not only with CAN SIC or CAN XL (xl_sic). The transmitting module state 403 (sic) can also be generated with CAN FD.

However, in CAN FD, the time for the transmitting module state 403 (sic) can be shorter than with CAN SIC or CAN XL.

The transmitting module 121 can thus generate two different bus states for CAN FD, three different bus states for CAN SIC and five different states for CAN XL.

If the transmitting/receiving device 12 is switched to the configuration in FIG. 5, the signals in FIG. 12 to FIG. 15 are received or generated at the terminals of the transmitting/receiving device 12. The transmitting/receiving device 12 can be switched to different operating modes LOW-POWER, NORMAL, TRANSMITTING, CONFIG, as specified in the international standard IEEE 802.3cg™ for 10BASE-TIS.

FIG. 12 shows an example of a time curve of a digital transmit signal Tx, which the transmitting/receiving device 12 receives from the communication control device 11A in FIG. 5 in order to transmit the transmit signal Tx as differential bus signals LINE+, LINE− according to the standard 10BASE-TIS to the bus 40A of the bus system 1A.

According to FIG. 12, the transmit signal Tx is divided over time t into multiple communication phases 460, 461, 462, which are allocated for transmission to the individual stations 10, 20, 30 by a master station. In the communication phases 460, 462, the operating mode NORMAL is switched on for the transmitting/receiving device 12, more precisely its transmission module 121 and reception module 122. In the communication phase 461, the transmitting/receiving device 12 may transmit to the bus 40A. For this reason, in the phase 461, the operating mode TRANSMITTING is switched on for the transmitting/receiving device 12, more precisely its transmission module 121 and reception module 122. The transmit permission is assigned according to a round-robin algorithm, in which each station receives a transmission time slot in a transmission cycle so that collisions on the bus 40 can be avoided. In the communication phases 460, 461, 462, the transmit signal Tx has bits with a bit time t_bt and the two different states HI (high), in particular 1, and LW (low), in particular 0.

As shown in FIG. 13, the transmitting/receiving device 12 transmits the transmit signal Tx in FIG. 12 as serial analog signals LINE+, LINE− to the bus 40A. The signals alternately have at least one state V0, also called VLINE_POS, and/or at least one state V1, also called VLINE_NEG.

According to FIG. 14, in the ideal case a differential signal V_L forms on the bus 40A over time t. In the state V0, U=V_L (V0)=+0.5 V. In the state V1, U=V_L (V1)=−0.5 V. Alternatively, it is possible that, in 10BASE-T1S single-drop, the state V1 (VLINE_POS) has a differential voltage VDIFF=+1.2 V and the state V0 (VLINE_NEG) has a differential voltage VDIFF=−1.2 V. In this case too, the resistance value R_IN_DIFF or R_IN of the internal resistance 1211 has a value of 100 ohms, as described in more detail below with reference to Table 3.

The reception module 122 can distinguish the states V0, V1 with, in each case, two of the reception thresholds T1_ETH, T2_ETH, T3_ETH, which lie in the ranges TH_T1, TH_T2, TH_T3. For this purpose, the reception module 122 samples the signals in FIG. 13 or FIG. 14 at predetermined times. For evaluating the sampling result, the reception module 122 uses all three reception thresholds T1_ETH, T2_ETH, T3_ETH in the operating modes NORMAL and TRANSMITTING. In contrast, the reception module 122 only uses the two reception thresholds T2_ETH, T3_ETH in the operating mode LOW-POWER. The reception threshold T1_ETH typically has a value of 0.0 V, the reception threshold T2_ETH typically has a value of +0.15 V, and the reception threshold T3_ETH typically has a value of −0.15 V. When switching between the operating modes (NORMAL, TRANSMITTING, LOW-POWER) described above with reference to FIG. 6, the reception module 122 switches the reception thresholds T1_ETH, T2_ETH, T3_ETH as required. Of course, at least the reception thresholds T2_ETH, T3_ETH for 10BASE-T1S single-drop for states V1, V0 of VDIFF=+1.2 V and −1.2 V can be set to different voltage values than mentioned above.

When receiving the corresponding signals from the bus 40, each transmitting/receiving device 12 generates the associated receive signal Rx, as shown in FIG. 15. Ideally, the receive signal Rx has no time offset from the transmit signal Tx.

For setting the configuration of the transmitting/receiving device 12 according to FIG. 4 for generating the signals on the bus 40 according to FIG. 7 or FIG. 11, or for setting the configuration of the transmitting/receiving device 12 according to FIG. 5 for generating the signals on the bus 40 according to FIG. 13, the transmitting/receiving device 12 proceeds as described below. After switching on the supply voltage at the terminal VCC, which is also called power-up, the transmission module 121 first remains in a high-impedance state on the bus side if possible. Here, “high-impedance state” means that the resistance value R_IN of the internal resistance 1211 in the transmission module 121 is set to a resistance value that is at least as high as the resistance value of the bus terminating resistor 49. This ensures that bus 40, 40A is not blocked with potentially incorrect symbols.

The transmission module 121 remains in the high-impedance state on the bus side until it is certain, by checking the criteria described below, whether a communication control device 11 is connected to the inputs of the transmitting/receiving device 12 so that the device 12 should behave according to the CAN, in particular CAN XL, standard, or whether a communication control device 11A is connected so that the device 12 should behave according to the 10BASE-T1S standard.

The COM-IF detection module 124 and/or the COM-IF determination module 125 forward the corresponding decision as an evaluation result to the operating mode selection module 123.

Once the checking and/or evaluation is completed using the module 123 and at least one of the modules 124, 125, in particular a decision on the communication standard is made or has been made, the transmitting/receiving device 12 behaves according to the corresponding communication standard.

However, the transmitting/receiving device 12 is designed to further check and/or evaluate at least one of the following criteria for plausibility. This ensures that any faults, such as a short circuit at the terminal STB/ED and/or at the terminal TX/TXD, are detected. The criteria for identifying the interface for the transmitting/receiving device 12 are as follows:

First Criterion (TX Edges when STB/ED=HIGH)

The module 124 is designed to check whether the terminal STB/ED is in the state HI (HIGH) and whether edges are being received at the terminal TXD/TX. If the terminal STB/ED is in the state HI (HIGH) and edges are received at the terminal TX, the module 124 decides that the connected communication control device is a communication control device 11A for 10BASE-T1S. The reason for this is that equivalent behavior for CAN XL does not exist.

Additionally or alternatively, the module 124 is designed for the first criterion to check whether a state LW (LOW) is signaled at the terminal STB/ED of the transmitting/receiving device 12. If a state LW (LOW) is signaled at the terminal STB/ED of the transmitting/receiving device 12, the module 124 decides that the connected communication control device is a communication control device 11 for CAN XL. The reason for this is that a communication control device 11 for CAN in CAN XL signals the switching of the operating mode from the operating mode Standby to the operating mode SLOW or Normal or SIC by a state LW (LOW) at the terminal STB/ED of the transmitting/receiving device 12.

Second Criterion (Periodic Reset Commands R_ST (RESET Commands) after Power-Up)

The module 124 is designed to check whether reset commands RS_C according to FIG. 16 are periodically transmitted at the terminal TXD/TX, with which reset commands the transmitting/receiving device 12 is to be switched from the initial LOW_POWER state to the NORMAL state according to the 10BASE-T1S protocol. In the 10BASE-T1S standard, a reset command RS_C is instead called RESET command. The lower part in FIG. 16 shows the state of a variable CMD over time t, which results from the signal waveform at the terminal TXD/TX over time t. “CMD” is an internal variable of a digital component of the transmitting/receiving device 12 (transceiver). The digital component can, for example, be part of module 123 and/or module 124. The value of the variable CMD is adjusted depending on the signaling at TX, more precisely based on the signal waveform at the terminal TXD/TX over time t. The value of the variable CMD is used to navigate the internal states. In other words, the value of the variable CMD is used to determine and/or transition between the internal states, which are NORMAL, TRANSMITTING, LOW_POWER, LOW_POWER_WAKE, CONFIGURATION. In the example shown in FIG. 16, the variable CMD has two defined states: N_N and R_ST. In the 10BASE-T1S standard, the state N_N is instead called NONE, and the state R_ST is called RESET. The state R_ST of the variable CMD means that a reset command was detected at the terminal TXD/TX. The state N_N means that no reset command has (yet) been detected at the terminal TXD/TX. The hatched states correspond to undefined states or states that are irrelevant in this context.

According to FIG. 16, a reset command RS_C has the state HI (HIGH) for a duration ttxda of at least 20 ns and then typically the state LW (LOW) for a duration ttxrst=80 ns. This is followed by a state HI (HIGH) for at least a duration tcgap of 20 ns. The duration tcgap is intended for a time between the reset commands RS_C. After such a reset command RS_C, the communication control device 11A waits for the transmitting/receiving device 12 to pull or switch the terminal STD/ED to the state LW (LOW) to indicate that the transmitting/receiving device 12 configured for 10BASE-T1S is ready to wake up.

The module 124 thus evaluates whether, after switching (powering) on the transmitting/receiving device 12, at least one reset command RS_C according to FIG. 16 is transmitted at the terminal TXD/TX, and the transmitting/receiving device 12 or the device 11A then pulls or switches the terminal STD/ED to the state LW (LOW). During the period until the transmitting/receiving device 12 or the device 11A has pulled the terminal STD/ED to the state LW (LOW), further reset commands RS_C, which were transmitted by a communication control device 11A, may periodically arrive at the terminal TXD/TX. The frequency of these pulses (reset commands RS_C) is not explicitly defined and is left to the manufacturer.

In addition, the module 124 evaluates whether the reset commands RS_C at the terminal TXD/TX are spaced apart by more than a duration of 245 ns. If the reset commands RS_C are spaced more than 245 ns apart, the module 124 decides that the connected communication control device is a communication control device 11A for 10BASE-T1S. The reason for this is that the maximum allowed symbol length for a PWM symbol LV0, LV1 in CAN XL is shorter than the duration of 245 ns, but a bit for the state 401 (dom) is 80 ns longer. The pattern checked by the module 124 is therefore too long for a PWM symbol LV0, LV1 but 80 ns too short for a dominant bit 401 (dom) in the operating mode CAN SIC.

In addition, the module 124 evaluates whether the reset commands RS_C arrive at the terminal TXD/TX at time intervals <245 ns. This evaluation takes into account that such a bit pattern can also represent CAN XL PWM symbols. In order to exclude this, the module 124 can wait for the maximum length of a CAN XL frame 450, which corresponds to the duration T_450 in FIG. 2. If no arbitration bits with the bit time t_bt1 for the CAN XL frame 450 are transmitted after the frame 450, the module 124 decides that the connected communication control device is a communication control device 11A for 10BASE-T1S. As a result, the transmitting/receiving device 12 pulls its terminal STB/ED to the state or voltage level LW (LOW) in order to switch to the operating mode NORMAL according to the 10BASE-T1S protocol.

### Third Criterion (Minimum Symbol Length)

The module 124 is designed to check the length of the transmitted symbols or the bit time t_bt2 at the terminal TXD/TX. If the symbol length is shorter than a predetermined time, in particular 45 ns or up to 49 ns, the module 124 decides that the connected communication control device is a communication control device 11A for 10BASE-T1S. One reason for this is that 45 ns is the shortest allowed symbol time that must be detected as such according to the CAN XL standard by the transmitting/receiving device 12. Another reason for this is that, in the CAN XL standard, the shortest allowed PWM symbols LV0, LV1 measured between two consecutive edges of the same polarity have a nominal duration of 50 ns in the FAST operating modes FAST_TX, FAST_RX. This corresponds to a data transmission rate of 20 Mbit/s. In contrast, a DME0 symbol in the standard 10BASE-T1S has a duration of only 40 ns.

The COM-IF detection module 124, for example, is a digital component that is, in particular, a discrete-time system. The COM-IF detection module 124 is operated at a prespecified frequency f, which is suitable for checking the signal at the terminal TXD/TX. In particular, the frequency f>400 MHz.

This allows the module 124 to reliably distinguish between the symbol lengths of 40 ns and 45 ns by checking the third criterion. The difference of, in particular, 5 ns can therefore be reliably distinguished by a sampling time.

### Fourth Criterion (Symbol Duty Cycle)

The module 124 is designed to check the duty cycle of the incoming symbols at the terminal TXD/TX.

In particular, the module 124 is designed to check whether symbols arrive with a duty cycle that is approximately 50%. If the duty cycle of a symbol is approximately 50%, the module 124 decides that the connected communication control device is a communication control device 11A for 10BASE-T1S. One reason for this is that, according to the standard 10BASE-T1S, a DME0 symbol at TX nominally consists of a 20 ns HIGH state and a 20 ns LOW state. This corresponds to a duty cycle of 50%. In contrast, CAN XL controllers of the device 11 transmit PWM symbols LV0, LV1 with a nominal duty cycle of 25% (LV0 symbol) and 75% (LV1 symbol), respectively.

Alternatively or additionally, the module 124 can be designed to check at the terminal TXD/TX whether the duty cycle of a symbol is greater than a prespecified first value, for example 60%, or less than a prespecified second value, for example 30%. If the duty cycle of a symbol is greater than the prespecified first value, for example 60%, or less than the prespecified second value, for example 30%, the module 124 decides that the connected communication control device is a communication control device 11 for CAN XL. Of course, under the aforementioned conditions for the duty cycle of the symbols, other values for the prespecified first value and/or the prespecified second value can be selected.

This allows the COM-IF detection module 124 to reliably detect the duty cycle length of a symbol at the terminal TXD/TX by checking the fourth criterion.

Depending on the result of the checks for the four criteria, the COM-IF detection module 124 decides which communication interface should be used by the transmitting/receiving device 12.

The COM-IF detection module 124 forwards the particular decision as an evaluation result to the operating mode selection module 123.

FIG. 17 shows in more detail the transmission module 121 for the transmitting/receiving device 12, which can be used for one of the stations 10, 30. The transmitting module 221 for the transmitting/receiving device 22 can be constructed in the same way as the transmitting module 121 for the transmitting/receiving device 12. For this reason, the transmitting module 221 is not described separately.

The transmission module 121 is connected to the bus 40, more precisely to its first bus wire 41 for CAN_H or CAN XL_H in a CAN bus system or LINE+ in a 10BASE-T1S bus system and to its second bus wire 42 for CAN_L or CAN XL_L in a CAN bus system or LINE− in a 10BASE-T1S bus system. Each of the transmission stages 121A to 121D is connected to the bus 40.

In addition, the control part 15 receives the signal B_SW from the operating mode selection module 123 (FIG. 3) and the transmit signal TxD in the case of CAN or a configuration according to FIG. 4 or the transmit signal Tx (FIG. 6) in the case of 10BASE-T1S or a configuration according to FIG. 5.

The transmission module 121 in FIG. 17 can, for example, generate the signals CAN_H, CAN_L according to FIG. 7 with the states 401, 402 or the states L0, L1. Instead of the states 401, 402, the transmission module 121 in FIG. 17 can generate the states 401, 402, 403, as shown in FIG. 11. Alternatively, the transmission module 121 in FIG. 17 generates signals for communication on the bus 40 according to 10BASE-TIS, in which communication the signal states V0, V1 are generated, as shown in FIG. 13.

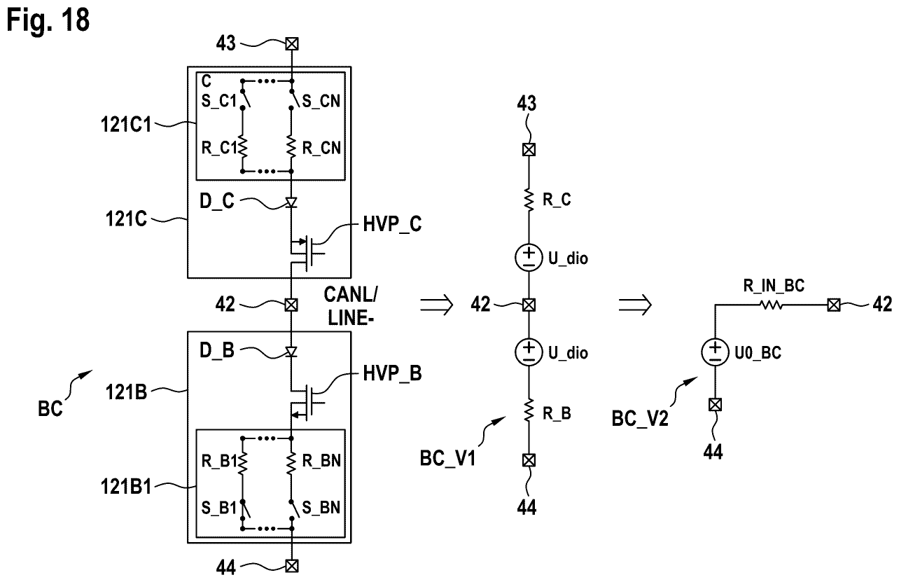

The transmitting module 121 has a first to fourth transmission stage 121A, 121B, 121C, 121D and a control part 15. As shown in FIG. 17, the transmission stages 121A to 121D are connected as a full bridge. The full bridge has a first half-bridge consisting of the transmission stages 121A, 121D and a second half-bridge consisting of the transmission stages 121B, 121C. The control part 15 is set for one of the operating modes by the operating mode selection module 123 (FIG. 3) by means of the signal B_SW and serves to control the transmission stages 121A, 121B, 121C, 121D according to the transmit signal TxD (FIG. 6) and the set operating mode SIC, FAST_TX for CAN XL or according to the transmit signal Tx (FIG. 12) and the operating modes of 10BASE-T1S of the transmission module 121. For this purpose, the control part 15 generates at least one signal N_A_1 for controlling the first transmission stage 121A, at least one signal N_B_1 for controlling the second transmission stage 121B, at least one signal N_C_1 for controlling the third transmission stage 121C and at least one signal N_D_1 for controlling the fourth transmission stage 121D. The control using the signals N_A_1 etc. is described in more detail with reference to FIG. 18 to FIG. 21.

The voltage supply for supplying the first and second bus wires 41, 42 with electrical energy, in particular with the voltage CAN Supply of typically 5 V, is effected via at least one terminal 43. The connection to ground, in particular CAN_GND, is realized via a terminal 44. The first and second bus wires 41, 42 are terminated with a terminating resistor 49. The terminating resistor 49 is connected in the full bridge as an external load resistor. The resistor 49 is connected in the bridge branch between the terminals for the bus wires 41, 42.

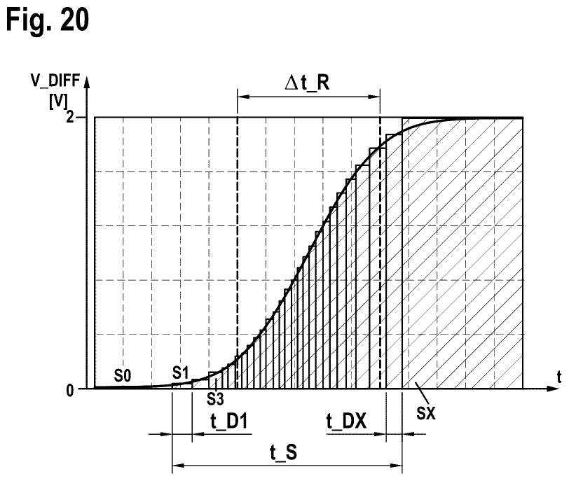

The first transmission stage 121A in FIG. 17 has a polarity reversal diode D_A, a transistor HVP_A, and a parallel circuit 121A1 in which a series circuit consisting of a first switch S_A1 and a first resistor R_A1 is connected in parallel to at least one series circuit consisting of an N-th switch S_AN and an N-th resistor R_AN for a first to N-th current stage, as shown in more detail in FIG. 20 and described below, where N is a natural number>1. With respect to the transmission stage 121A, the number N is also referred to below as N_A. The parallel circuit 121A1 therefore has a resistance value R_A that can be set using the switches S_A1 to S_AN. The transistor HVP_A is a CMOS transistor, in particular a PMOS transistor, the control of which is not shown in detail in FIG. 17 to simplify the drawing. The abbreviation “CMOS” refers to a semiconductor device that uses both p-channel and n-channel MOSFETs on a common substrate. The abbreviation CMOS stands for “complementary metal-oxide semiconductor.” The abbreviation “MOSFET” stands for “metal oxide semiconductor field-effect transistor.”

The second transmission stage 121B in FIG. 17 has a polarity reversal diode D_B, a transistor HVN_B, and a parallel circuit 121B1 in which a series circuit consisting of a first switch S_B1 and a first resistor R_B1 is connected in parallel to at least one series circuit consisting of an N-th switch S_BN and an N-th resistor R_BN for a first to N-th current stage, where N is the natural number>1. With respect to the transmission stage 121B, the number N is also referred to below as N_B. The parallel circuit 121B1 therefore has a resistance value R_B that can be set using the switches S_B1 to S_BN. The transistor HVN_B is a CMOS transistor, in particular an NMOS transistor, the control of which is not shown in detail in FIG. 17 to simplify the drawing.

The third transmission stage 121C in FIG. 17 has a polarity reversal diode D_C, a transistor HVP_C, and a parallel circuit 121C1 in which a series circuit consisting of a first switch S_C1 and a first resistor R_C1 is connected in parallel to at least one series circuit consisting of an N-th switch S_CN and an N-th resistor R_CN for a first to N-th current stage, where N is the natural number>1. With respect to the transmission stage 121C, the number N is also referred to below as N_C. The parallel circuit 121C1 therefore has a resistance value R_C that can be set using the switches S_C1 to S_CN. The transistor HVP_C is a CMOS transistor, in particular a PMOS transistor, the control of which is not shown in detail in FIG. 17 to simplify the drawing.

The fourth transmission stage 121D in FIG. 17 has a polarity reversal diode D_D, a transistor HVN_D, and a parallel circuit 121D1 in which a series circuit consisting of a first switch S_D1 and a first resistor R_D1 is connected in parallel to at least one series circuit consisting of an N-th switch S_DN and an N-th resistor R_DN for a first to N-th current stage, where N is the natural number>1. With reference to the transmission stage 121D, the number N is also referred to below as N_D. The parallel circuit 121D1 therefore has a resistance value R_D that can be set using the switches S_D1 to S_DN. The transistor HVN_D is a CMOS transistor, in particular an NMOS transistor, the control of which is not shown in detail in FIG. 17 to simplify the drawing.

Each series circuit of the parallel circuits 121A1, 121B1, 121C1, 121D1 implements one of the current stages S1 to SN of the transmission stages 121A to 121D. For this purpose, the current stages S1 to SN of the transmission stages 121A to 121D are designed as resistance stages, which can also be referred to as resistance fingers. The resistance stages are set by selecting the resistance value of the corresponding current stage, for example by selecting the resistors R_A1 to R_AN for the transmission stage 121A, etc. As a result of setting the resistance values of the resistors, the currents and thus current stages generated by the associated transmission stage 121A to 121D are set. The number N can be chosen arbitrarily. In particular, the number N and thus the number of stages or number of resistance stages or current stages can be selected between 1 and 60. Alternatively, N can be a number greater than 60, as shown in Table 4 below.

Each of the polarity reversal diodes D_A, D_B, D_C, D_D protects the associated transmission stage against positive feedback to the terminal 44 (CAN Supply) and negative feedback to the terminal 43 (CAN_GND). Each of the polarity reversal diodes D_A, D_B, D_C, D_D can also be called a blocking diode.

Each of the parallel circuits 121A1, 121B1, 121C1, 121D1, more precisely with control by the control part 15, sets a resistance or resistance value R_A, R_B, R_C, R_D for the associated transmission stage 121A, 121B, 121C, 121D depending on the communication standard used or to be used on the bus 40, 40A, and the operating mode of the transmission module 121 and of the transmit signal TxD. The communication standards are, in particular, CAN_XL or 10BASE-T1S. The operating mode of the transmission module 121 is, for example, SLOW or SIC or FAST_TX for CAN_XL or multi-drop or single-drop for 10BASE-TIS. In the two operating modes multi-drop and single-drop for 10BASE-T1S, a midpoint voltage VCM on the bus 40 or DC common mode is not defined, since there is AC decoupling with the module 14, as described above with reference to FIG. 5.

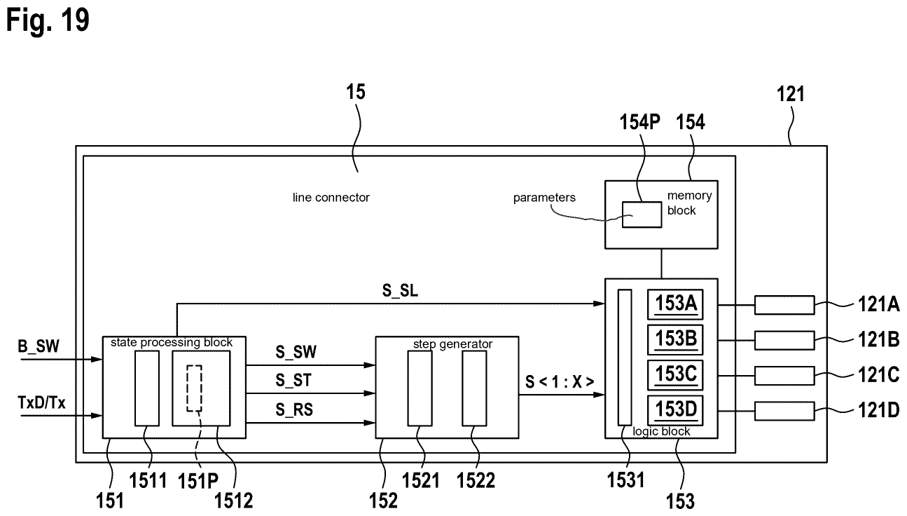

The resistance value of the individual transmission stage 121A, 121B, 121C, 121D is therefore settable depending on the operating mode of the transmission module 121 and of the received transmit signal TxD (FIG. 6 or FIG. 10) or Tx (FIG. 12). This is described in more detail below with reference to FIG. 19 to FIG. 21 and Tables 3 to 6.

Each of the transistors HVP_A, HVN_B, HVP_C, HVN_D is an HV cascode and can also be called an HV standoff device. The transistor HVP_A protects the parallel circuit 121A1 by absorbing high voltage drops. Each of the transistors HVN_B, HVP_C, HVN_D has the same function for the corresponding parallel circuit 121B1, 121C1, 121D1. Each of the transistors HVP_A, HVN_B, HVP_C, HVN_D can be controlled accordingly at its control terminal, in particular by the control part 15 or another control device not shown.

For the configuration according to FIG. 4, in the transmission module 121, the transmission stage 121A is connected between the terminal 43 for the voltage supply and the terminal 41 (CANH) for the signal CAN_H. In addition, the transmission stage 121C is connected between the terminal 43 for the voltage supply and the terminal 42 (CANL) for the signal CAN_L and the terminal 43 for ground or the terminal 44 (CAN_GND). In addition, the transmission stage 121D is connected between the terminal 41 (CANH) for the signal CAN_H and the terminal 43 for ground or the terminal 44 (CAN_GND). And, the transmission stage 121B is connected between the terminal 42 (CANL) for the signal CAN_L and the terminal 43 for ground or the terminal 44 (CAN_GND). For a configuration according to FIG. 4, in the transmission module 121, firstly the transmission stage 121A is thus connected into the CANH path. Secondly, the transmission stage 121D is connected into the CANH path. Firstly the transmission stage 121C is connected into the CANL path. Secondly the transmission stage 121B is connected into the CANL path.

In the configuration according to FIG. 4, the signals CAN_H, CAN_L form the differential signal transmitted by the transmission module 121 in FIG. 17 to the bus 40.

Thus, in the configuration according to FIG. 4, the transmission module 121 consists, in the CANH path and in the CANL path, of a parallel circuit 121A1, 121B1, 121C1, 121D1 of a prespecified number of current stages or resistance fingers, as described above. The parallel circuit of all current stages is connected, in the CANH path and in the CANL path, in series with an HV cascode HVP_A, HVN_B, HVP_C, HVN_D and a polarity reversal diode D_A, D_B, D_C, D_D, as described above. The HV cascodes HVP_A, HVN_B, HVP_C, HVN_D make it possible to comply with limit values (maximum rating parameters), such as voltage at CANH and CANL of −27 V to +40 V.

In the configuration according to FIG. 5, the signals LINE+ LINE− form the differential signal transmitted by the transmission module 121 in FIG. 17 to the bus 40. The same thus applies to the transmission module 121 in the configuration according to FIG. 5 for a path for LINE+ at the terminal 41 and for a path for LINE− at the terminal 42.

The transmission module 121 shown in FIG. 17 and described above can generate various electrical states, which are defined by their open-circuit voltage V0 and the resistance value R_IN of their internal resistance 1211 (FIG. 3). For this purpose, the resistance values of the resistors R_A1 to R_AN of the transmission stage 121A, more precisely of their parallel circuit 121A1, are set accordingly. The resistance values are set by switching the parallel resistance fingers R_A1, R_A2, . . . , R_AN and/or the resistance fingers of the other transmission stages 121B, 121C, R_D on or off. This is explained in more detail below with reference to FIG. 18. For setting the resistance values of the transmission module 121, the half-bridge AD consisting of the transmission stages 121A, 121D and the half-bridge BC consisting of the transmission stages 121B, 121C must be considered.

FIG. 18 shows the half-bridge BC consisting of the transmission stages 121B, 121C between the terminals 43, 44 and at the bus terminal 42 for CAN_L or LINE−, for example. The half-bridge BC is simplified into the circuits BC_V1 and BC_V2 according to the following considerations, as shown by the block arrows in FIG. 18. The same applies to the half-bridge AD consisting of the transmission stages 121A, 121D so the half-bridge AD is not shown additionally.

For the setting of the resistance values of the transmission module 121, it is assumed for simplification that the parasitic electrical resistances of the cascodes HVP_A, HVP_B, HVP_C, HVP_D, the switches S_A1 . . . S_AN, S_B1 . . . . S_BN, S_C1 . . . . S_CN, S_D1 . . . . S_DN and the diodes D_A, D_B, D_C, D_D of the transmission stages 121A, 121B, 121C, 121D are negligible. This results in the simplified half-bridge BC_V1 with the resistors or resistance values R_B, R_C in the middle of FIG. 18.

Considering the open-circuit voltages V0_AD, V0_BC of the mentioned half-bridges AD, BC, with the supply voltage VCC, which is fed in at terminal 43, the following results:

$$\begin{matrix}V 0 \_AD = ( VCC + ( VCC - 2 * U\_dio ) * ( R\_D - R\_A ) / ( R\_D + R\_A ) ) / 2 \\ V 0 \_BC = ( VCC + ( VCC - 2 * U\_dio ) * ( R\_B - R\_C ) / ( R\_B + R\_C ) ) / 2\end{matrix}$$

The open-circuit voltage V0_BC is illustrated in the further simplified half-bridge BC_V2 on the right in FIG. 18.

The setting of the resistance values of the transmission module 121 also takes into account that emissions of the transmission module 121 are caused by signal fluctuations that arise due to the DC choke 13 in FIG. 4 or FIG. 5 and are also called common-mode signal fluctuations. For minimizing these unwanted emissions, the transmission module 121 is designed to set as constant the bus midpoint voltage VCM=(V0_AD+V0_BC)/2 generated by the transmission module 121. The following is therefore true:

$$VCM = VCC / 2 ( constant ) .$$

For this purpose, the transmission module 121 is designed to set

$$\begin{matrix}R\_A = R\_B := R\_M ( main branch ) \\ and \\ R\_C = R\_D := R\_CP ( complementary branch ) .\end{matrix}$$

The resistance value R_IN of the internal resistance 1211 (FIG. 3), or the conductance G_IN, and the open-circuit voltage U0 of the transmission module 121 are then given by

$$\begin{matrix}R\_IN = 1 / G\_IN = R\_IN \_AD + R\_IN \_BC \\ = 2 * ( R\_M * R\_C ) / ( R\_M + R\_C ) = 1 / ( G\_M + G\_CP ) \\ U 0 = U 0 \_AD - U 0 \_BC = U\_X * ZBUS * ( GM - GC ) / ( 1 + ZBUS * G\_IN )\end{matrix}$$

Here, R_IN_AD is the internal resistance or its value of the half-bridge AD consisting of the transmission stages 121A, 121D. In addition, R_IN_BC is the internal resistance or its value of the half-bridge BC consisting of the transmission stages 121B, 121C, as shown in FIG. 18. In addition, U0_AD is the open-circuit voltage of the half-bridge AD consisting of the transmission stages 121A, 121D, and U0_BC is the open-circuit voltage of the half-bridge BC consisting of the transmission stages 121B, 121C, which is shown in FIG. 18. Furthermore, ZBUS is the wave impedance of the bus 40. Furthermore, the following applies to the conductance G_M of the main branch, the conductance G_CP of the complementary branch, and a voltage U_X:

$$\begin{matrix}G\_M = 1 / ( 2 * R\_M ) \\ G\_CP = 1 / ( 2 * R\_CP ) \\ U\_X = VCC - 2 * U\_dio\end{matrix}$$

This results in the following values for the resistors R_M (main branch) and R_CP (complementary branch):

$$\begin{matrix}R\_M = ZBUS * U\_X / ( U\_X * ZBUS * Gin + U 0 ( 1 + ZBUS * Gin ) ) \\ R\_CP = ZBUS * U\_X / ( U\_X * ZBUS * Gin - U 0 ( 1 + ZBUS * Gin ) )\end{matrix}$$

The following Table 3 shows the electrical properties generated by the transmission module 121 of the transmitting/receiving device 12 for the states in CAN XL (REC, SIC, DOM, L1, L0) for a bus 40, which is terminated with a resistor 49 with the impedance Z_Bus and supplied with a supply voltage VCC. In addition, Table 3 shows the electrical properties generated by the transmission module 121 of the transmitting/receiving device 12 for the states V0, V1 in 10BASE-T1 for the different operating modes for 10BASE-T1 (single-drop mode, multi-drop mode with VCC=5 V and multi-drop mode with VCC=3.3 V) for a bus 40A, which is terminated with a resistor 49 with the impedance Z_Bus and supplied with a supply voltage VCC. The state V0 is also called VLINE_POS. The state V1 is also called VLINE_NEG. Table 3 assumes that, for the transmission module 121, the diode voltage U_dio=0.7 V and the impedance of a single resistance finger R_finger=10 kOhm.

TABLE 3
Electrical properties of the transmission module states

| | | | | | | R_A = | R_C = |
|---|---|---|---|---|---|---|---|
| | | | | | | R_B: = | R_D: = |
| | | V_DIFF | VCC | R_IN_DIFF | Z_Bus | R_M | R_CP |
| Standard | State | (V) | (V) | (ohm) | (ohm) | (ohm) | (ohm) |
| CAN_XL | 402 (rec) | 0 | 5 | infinite | 50 | infinite | infinite |
| CAN_XL | 403 (sic) | 0 | 5 | 100 | 50 | 100 | 100 |
| CAN_XL | 401 (dom) | 2 | 5 | 40 | 50 | 20 | infinite |
| CAN_XL | L0 | 1 | 5 | 100 | 50 | 54.5 | 600 |
| CAN_XL | L1 | −1 | 5 | 100 | 50 | 600 | 54.5 |
| 10BASE-T1S | V0 | 0.5 | 5 | 100 | 50 | 70.6 | 171.4 |
| multi-drop | | | | | | | |
| 10BASE-T1S | V1 | −0.5 | 5 | 100 | 50 | 171.4 | 70.6 |
| multi-drop | | | | | | | |
| 10BASE-T1S | V0 | 0.5 | 3.3 | 100 | 50 | 55.9 | 475 |
| multi-drop | | | | | | | |
| 10BASE-T1S | V1 | 0.5 | 3.3 | 100 | 50 | 475 | 55.9 |
| multi-drop | | | | | | | |
| 10BASE-T1S | V0 | 0.5 | 5 | 100 | 100 | 70.6 | 171.4 |
| single-drop | | | | | | | |
| 10BASE-T1S | V1 | 0.5 | 5 | 100 | 100 | 70.6 | 171.4 |
| single-drop | | | | | | | |

The number of connected fingers in the individual elements of the H-bridge N_A, N_B, N_C, N_D is then as given in Table 4 below.

TABLE 4
Number of resistance fingers, each with a resistance R_finger =
10 kOhm, for transmission module states with a diode voltage U_dio = 0.7 V
and with the electrical resistances R_M and R_CP according to Table 3

| | | R_A = | R_C = | | | | |
|---|---|---|---|---|---|---|---|
| | | R_B: = | R_D: = | | | | |
| | | R_M | R_CP | | | | |
| Standard | State | (ohm) | (ohm) | N_A | N_B | N_C | N_D |
| CAN_XL | 402 (rec) | infinite | infinite | 0 | 0 | 0 | 0 |
| CAN_XL | 403 (sic) | 100 | 100 | 100 | 100 | 100 | 100 |
| CAN_XL | 401 (dom) | 20 | infinite | 500 | 500 | 0 | 0 |
| CAN_XL | L0 | 54.5 | 600 | 183 | 183 | 17 | 17 |
| CAN_XL | L1 | 600 | 54.5 | 17 | 17 | 183 | 183 |
| 10BASE-T1S | V0 | 70.6 | 171.4 | 142 | 142 | 58 | 58 |
| multi-drop | | | | | | | |
| 10BASE-T1S | V1 | 171.4 | 70.6 | 58 | 58 | 142 | 142 |
| multi-drop | | | | | | | |
| 10BASE-T1S | V0 | 55.9 | 475 | 179 | 179 | 21 | 21 |
| multi-drop | | | | | | | |
| 10BASE-T1S | V1 | 475 | 55.9 | 21 | 21 | 179 | 179 |
| multi-drop | | | | | | | |
| 10BASE-T1S | V0 | 70.6 | 171.4 | 167 | 167 | 33 | 33 |
| single-drop | | | | | | | |
| 10BASE-T1S | V1 | 70.6 | 171.4 | 33 | 33 | 167 | 167 |
| single-drop | | | | | | | |

The resistance fingers of the transmission stages 121A, 121B, 121C, 121D can be switched as described below with reference to FIG. 19 to FIG. 21 and with reference to the following Tables 5, 6.

The basic operation of the circuit in FIG. 17 according to the operating mode of the transmission module 121 and the bus state 401 (dom), 403 (sic), 402 (rec) in the SIC operating mode (arbitration phase 451) and the bus states L0, L1 in the data phase 452 is explained as an example with reference to FIG. 19 to FIG. 21 and the following Tables 5, 6. The circuit in FIG. 17 functions accordingly for generating the states V0, V1 for the communication standard 10BASE-T1S.

FIG. 19 shows in more detail the control part 15 of the transmission module 121 for the transmitting/receiving device 12, which control part can be used for the stations 10, 30 of the bus system 1. The transmitting/receiving device 22 for the station 20 can be constructed in the same way as described below for the transmitting/receiving device 12.

The control part 15 has a state processing block 151, a step generator 152, a logic block 153 and a memory block 154. The operating mode selection signal B_SW is input into the control part 15, and either the transmit signal TxD (FIG. 6 or FIG. 11) or the transmit signal Tx (FIG. 12 or FIG. 16) is also input. On the basis of these signals, the control part 15 generates control signal(s) for the transmission stages 121A to 121D. The state processing block 151, the step generator 152, and the logic block 153 form a control chain or chain for the step-by-step generation of the transmission currents of the transmitting module 121, which are required for a low-emission transition between two bus signal states or bus states 401, 402, 403, LV0, LV1.

In FIG. 19, the state processing block 151 has an evaluation unit 1511 and a signal generation unit 1512. The evaluation unit 1511 evaluates the transmit signal TxD with respect to the current signal state of the digital transmit signal TxD and the operating mode which is switched for the transmitting module 121. The evaluation result of the evaluation unit 1511 for a received transmit signal TxD according to FIG. 5 or FIG. 7 can therefore be HI (high) or LW (low). The operating mode (SIC, FAST_TX) to which the transmitting module 121 is switched then determines which of the bus signal states or bus states 401, 402, 403, LV0, LV1 is to be generated. In addition, the evaluation unit 1511 can evaluate whether the signal state of the digital transmit signal TxD has changed compared to the previous signal state of the digital transmit signal TxD and/or whether the operating mode of the transmitting module 121 has changed.

The signal generation unit 1512 is designed to generate signals S_SL, S_SW, S_ST when the evaluation result of the evaluation unit 1512 shows that switching between two of the bus states 401, 402, 403, LV0, LV1 is to be carried out and thus a transition between two of the bus states 401, 402, 403, LV0, LV1 is to be generated. Accordingly, the signal generation unit 1512 generates a selection signal S_SL, a slew rate signal S_SW and a step start signal S_ST according to the evaluation of the evaluation unit 1511. The signals S_SL, S_SW, S_ST are different depending on the type of transition, for example from state 401 (dom) to state 403 (sic). Optionally, at least one of the signals S_SL, S_SW, S_ST is generated using parameters 151P. The parameters 151P can be stored in the signal generation unit 1512 or are available by accessing the memory block 154.

The signal generation unit 1512 outputs the selection signal S_SL to the logic block 153. In contrast, the signal generating unit 1512 outputs the slew rate signal S_SW, the step start signal S_ST and the reset signal S_RS to the step generator 152.

When the control of a transition between the two bus signal states is complete, for example for a transition from state 401 (dom) to state 403 (sic), the signal generation unit 1512 generates a reset signal S_RS.

The step generator 152 has an evaluation unit 1521 and a signal generation unit 1522. The evaluation unit 1521 evaluates the slew rate signal S_SW and the step start signal S_ST. The signal generation unit 1522 generates a step signal s<1:X> on the basis of this evaluation and outputs it to the logic block 153, as described in more detail below. X is any natural number greater than 1. The step signal S<1:X> is designed to change, step by step, the resistance values and thus the transmission currents of the transmission stages 121A, 121B, 121C, 121D of the transmitting module 121.

The logic block 153 can be designed as a programmable logic. The logic block 153 controls the transmission stages 121A, 121B, 121C, 121D of the transmitting module 121, in particular using control units 153A, 153B, 153C, 153D and parameters 154P. The parameters 154P are stored in the memory block 154. The control unit 153A is designed to control the transmission stage 121A, in particular its parallel circuit 121A1. The control unit 153B is designed to control the transmission stage 121B, in particular its parallel circuit 121B1. The control unit 153C is designed to control the transmission stage 121C, in particular its parallel circuit 121C1. The control unit 153D is designed to control the transmission stage 121D, in particular its parallel circuit 121D1.

Setpoints, in particular in the form of parameters 154P, for the parallel circuits 121A1, 121B1, 121C1, 121D1 in FIG. 17 are stored in the memory block 154 for all permitted transitions between signal states on the bus 40 for each step in the transition. In a CAN bus system, the transitions are, for example, the transition from state 401 (dom) to state 403 (sic), the transition from state 403 (sic) to state 401 (dom), the transition from state LV0 to state LV1 and the transition from state LV1 to state LV0 and so on.

The logic block 153 is designed to carry out a control which sets the setpoints for the parallel circuits 121A1, 121B1, 121C1, 121D1 in FIG. 17. The setpoints stored in the parameters 154P for the parallel circuits 121A1, 121B1, 121C1, 121D1 in FIG. 17 can be set as desired so that, in particular, the emissions of the transmission module 121 are low so that the electromagnetic compatibility (EMC) requirements of the transmission module 121 are met.

The following Tables 5, 6 show an example of setpoints which can be stored in the memory block 154. In the example in Tables 5, 6, the logic block 153 controls the parallel circuits 121A1, 121B1, 121C1, 121D1 in FIG. 17 such that the parallel circuits 121A1, 121B1, 121C1, 121D1 in FIG. 17 successively assume 30 different resistance values R_A, R_B, R_C, R_D. As a result, for each of the 30 steps S1 to S30, different differential resistances R_DIFF or impedances of the transmission stages 121A/121B and 121C/121D and different differential voltages VDIFF arise on the bus 40, as indicated in Table 5. This completes the transition from 401 to 403 in 30 steps S1 to S30. Table 6 indicates the number N_A of actively switched resistance fingers for the transmission stage 121A, the number N_B of actively switched resistance fingers for the transmission stage 121B, the number N_C of actively switched resistance fingers for the transmission stage 121C, and the number N_D of actively switched resistance fingers for the transmission stage 121D of the transmission module 121.

The steps S1 to S30 are also referred to below as intermediate states on the bus 40.

TABLE 5
Example of electrical setpoints for transition 401 to 403 in 30 steps S1 to
S30 or S1, . . . S30 according to the number of resistance fingers in Table 3

| | Step / | | | | | | |
|---|---|---|---|---|---|---|---|
| | intermediate | V_DIFF | R_DIFF | R_A | R_B | R_C | R_D |
| State | state | (V) | (ohm) | (ohm) | (ohm) | (ohm) | (ohm) |
| 401 (dom) | S0 | 2 | 40 | 20 | 20 | infinite | infinite |
| Intermediate | S1 | 1.96 | 41 | 21 | 21 | 7k | 7k |
| state | | | | | | | |
| Intermediate | S2 | 1.9 | 43 | 22 | 22 | 2.3k | 2.3k |
| state | | | | | | | |
| Intermediate | . . . | . . . | . . . | . . . | . . . | . . . | . . . |
| state | | | | | | | |
| Intermediate | S29 | 0.03 | 99 | 96 | 96 | 101 | 101 |
| state | | | | | | | |
| 403 (sic) | S30 | 0 | 100 | 100 | 100 | 100 | 100 |

TABLE 6
Example number of resistance fingers in parallel circuits
121A1, 121B1, 121C1, 121D1 in FIG. 17 for transition 401
to 403 in 30 steps S1 to S30 or S1, . . . S30 for CAN XL for single
resistance fingers where R_finger = 10 kOhm, polarity reversal
diode protection voltages of 0.7 V, power supply voltage Vcc =
5 V at terminal 43 and an impedance Z_Bus = 50 kOhm
for the resistor 49

| | Step/intermediate | | | | |
|---|---|---|---|---|---|
| State | state | N_A | N_B | N_C | N_D |
| 401 (dom) | S0 | 500 | 500 | 0 | 0 |
| Intermediate state | S1 | 485 | 485 | 1 | 1 |
| Intermediate state | S2 | 461 | 461 | 4 | 4 |
| Intermediate state | . . . | . . . | . . . | . . . | . . . |
| Intermediate state | S29 | 104 | 104 | 98 | 98 |
| 403 (sic) | S30 | 100 | 100 | 100 | 100 |

During operation of the transmitting module 121, the state processing block 151 uses the transmit signal TxD at the input to decide when to carry out which transition, in particular with the evaluation unit 1511.

In order to initiate a transition, in particular from the bus state 401 (dom) to the bus state 403 (sic), the corresponding combinatorial circuit for the number N_A, N_B, N_C and N_D of the resistors R_A1 etc. in the parallel circuits 121A1, 121B1, 121C1, 121D1 is first selected by the selection signal S_SL in the logic block 153. In addition, in particular at the same time, the desired signal slew rate for the bus signal (CAN_H; CAN_L) is set for the upcoming transition according to the specification of the slew rate signal S_SW and the chain; in particular the step generator 152, is reset to an initial value via the reset signal S_RS.

The circuit in FIG. 19 thus forms a delay chain which runs successively through the mentioned steps S1 to SX in one direction. This simplifies the switching of a transition. In addition, the current consumption is reduced compared to a circuit which has more than one delay chain, in particular with 3 delay chains or 3 times 2 delay chains, as described above with respect to the related art.

The state processing block 151 is designed to generate the step start signal S_ST such that the step generator 152 is started only after a predetermined delay time in order to complete the transition between the bus states. Thus, the delay chain is started or initiated only after a prespecified delay time in order to complete the transition between the two consecutive bus states. For example, the prespecified delay time is about 1 ns, in particular a time between 1 ns and 5 ns. The prespecified delay time ensures that both the step generator 152 and the logic block 153 are ready to make the desired transition between bus states.

The step generator 152, in particular its signal generation unit 1522, thus generates the control signals or step signals for the steps S1, . . . , SX, which signals change their state one after the other at time intervals t_D1, . . . , t_DX, in particular to HI (high).

FIG. 20 shows an example of a curve of the bus voltage U in relation to the maximum voltage Um of the transition controlled by the control part 15 in FIG. 19 for the transmission stage 121 between the states 401 (dom) and 403 (sic). In the example shown in FIG. 20, the control part 15 controls the transition over time t in steps S1, . . . , SX and time intervals t_D1, . . . , t_DX. For the sake of clarity, not all steps S1 to SX, which correspond to intermediate states on the bus 40 and time intervals t_D1, . . . , t_DX, are labeled in FIG. 20.

The example in FIG. 20 shows an asynchronous time step generation for generating the transition between the bus signal states 401 (dom), 403 (sic). Such a time step generation by means of the control part 15 asynchronously specifies a fixed form of time steps S1, . . . , SX for the transition, which as individual signals for each of the intermediate states or steps S1, . . . , SX form the output of the step generator 152 and the control part 15. This also results in a predetermined rise time Δt_R of the edge between the two states on the bus 40.

The ratio of the length of a time step t_Dn to the total switching time t_S=t_D1+ . . . +t_DX is constant. In the middle (the steepest part of the curve) the time steps are short and at the beginning and end they are longer. The total length t_S of the transition can be adjusted by setting a bias current to adjust the slew rate of the transition.

The course of the transition between two states of states 401, 402, 403, LV0, LV1 can be set freely. By using longer time steps t_D1, . . . t_DX at the beginning and end of the transition or sequence than in the middle, a spectrally optimal “smooth” overall transition from one state to the other can be approximated.

An advantage of the above-described asynchronous step chain for the transmitting module 121 compared to a synchronous step chain controlled by a regular clock signal is primarily that the described step chain of the transmitting module 121 has significantly better emission behavior.

The reason for this is that the high frequency spectral components of the signals on the bus 40 are distributed more evenly over the frequency range rather than being concentrated at integer multiples of the clock frequency. For the same number of steps per transition or step sequence, the maximum of the spectrum is significantly lower over the high frequency range of 100 MHz-3 GHz.

The speed of the step chain then defines the time in which this transition between the states takes place. The speed of the transitions 401, 402, 403, LV0, LV1 is limited only by the maximum switching speed of the resistance fingers used in the transmission stages 121A, 121B, 121C, 121D.

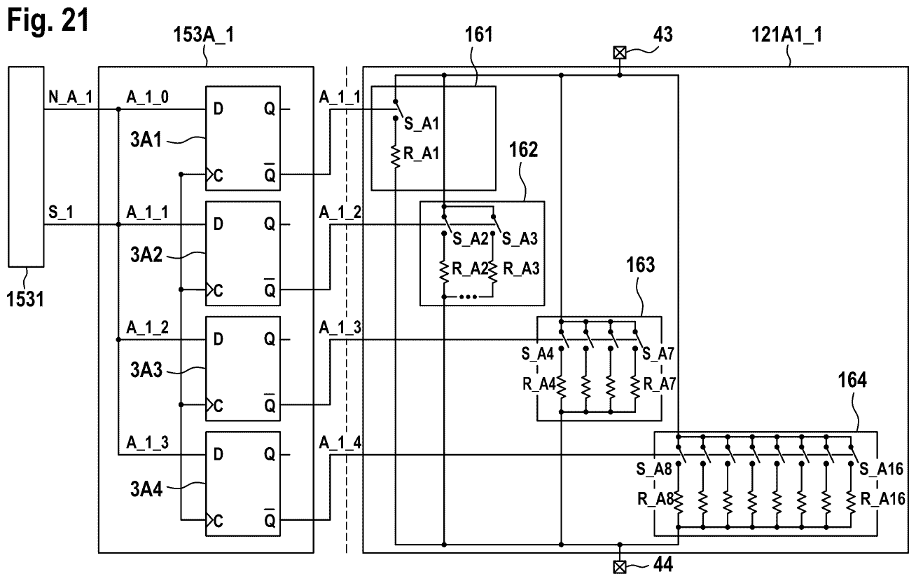

In order to produce a transition as shown in FIG. 20 on the bus 40, each of the four resistor arrays or parallel circuits 121A1, 121B1, 121C1, 121D1 in the H-bridge in FIG. 17 has individual resistor cells, each of which has a control cell provided in the logic block 153, as described with reference to FIG. 21.

For the parallel circuit 121A1 for the intermediate state or time step S1, FIG. 21 shows an example of one of the resistor cells 121A1_1 and a corresponding control cell 153A_1 for the time step S1. For each time step S1, . . . , SX, there is one resistor cell 121A1_1 and one corresponding control cell 153A_1 per parallel circuit 121A1, 121B1, 121C1, 121D1, as shown in FIG. 21. All control cells 153A_1 for steps S2 to SX are identically constructed.

Accordingly, the transmitting module 121 has a total of 30 resistor cells 121A1_1 per individual transmission stage 121A1, 121B1, 121C1, 121D1. Thus, each parallel circuit 121A1, 121B1, 121C1, 121D1 has a total of 30 resistor cells 121A1_1. In the present example for controlling 30 time steps, the transmission module 121 therefore has 4 times 30=120 resistor cells 121A1_1 as well as 4 times 30=120 control cells 153A_1.

According to FIG. 21, the resistor cell 121A1_1 has binary weighted switchable resistor elements S_A1, R_A1, etc. which are connected in resistor blocks 161, 162, 163, 164. The resistance values of the resistor elements S_A1, R_A1, etc. and/or the resistor blocks 161, 162, 163, 164 can be selected for the individual resistor cell 121A1_1 as required. The resistance values of the resistor elements S_A1, R_A1 etc. and of the resistor blocks 161, 162, 163, 164 can be identical or at least partially different for the resistor cells 121A1_1 of the individual transmission stages 121A1, 121B1, 121C1, 121D1.

Each of the parallel circuits 121A1, 121B1, 121C1, 121D1 thus has binary weighted switchable resistor elements which are suitably switched for the applicable step S1 to SX (FIG. 20) according to the step signal S<1:X> in FIG. 19. In the example in FIG. 21, the resistor cell 121A1_1 is switchable with 4 bits.

FIG. 21 shows the design of the resistor cell 121A1_1 of the parallel circuit 121A1 for the example that 16 resistance fingers or resistor elements are connected in four resistor blocks 161, 162, 163, 164 which have switches S_A1 to S16 and resistors R_A1 to R_A16. Therefore, N=16. The parallel circuits 121B1, 121C1, 121D1 are designed in the same way in this example and are therefore not described separately.

For example, the resistors R_A1 to R_A16 all have the same resistance value. The resistance value 8 kOhm is assumed as an example below for each of the resistors R_A1 to R_A16. The switches S_A1 to S16 can in particular be CMOS transistors, in particular PMOS transistors. The same applies to switches S_A1 to S16 of the parallel circuit 121C1. The switches S_A1 to S16 of the parallel circuits 121B1, 121D1 can in particular be CMOS transistors, in particular NMOS transistors.

The first resistor block 161 has a resistor in a series circuit formed by the first switch S_A1 and the first resistor R_A1. When the first switch S_A1 is switched to be conductive, the resistor block 161 in the resistor cell 121A1_1 acts with a total resistance value of 8 kOhm in the example given.

The second resistor block 162 has two resistors R_A2, R_A3 in two series circuits connected in parallel. Thus, block 162 has a series circuit consisting of a second switch S_A2 and a second resistor R_A2 and a series circuit consisting of a third switch S_A3 and a third resistor R_A3. When the second and third switches S_A2, S_A3 are switched to be conductive, the resistor block 162 in the resistor cell 121A1_1 acts with a total resistance value of 4 kOhm.

The third resistor block 163 has four resistors R_A4 to R_A7 in four series circuits connected in parallel. Thus, block 163 has a series circuit consisting of a fourth switch S_A4 and a fourth resistor R_A4 up to a series circuit consisting of a seventh switch S_A7 and a seventh resistor R_A7. When the fourth to seventh switches S_A4 to S_A7 are switched to be conductive, the resistor block 163 in the resistor cell 121A1_1 acts with a total resistance value of 2 kOhm.

The fourth resistor block 164 has eight resistors R_A8 to R_A16 in eight series circuits connected in parallel. Thus, block 164 has a series circuit consisting of an eighth switch S_A8 and an eighth resistor R_A8 up to a series circuit consisting of a sixteenth switch S_A16 and a sixteenth resistor R_A16. When the eighth to sixteenth switches S_A8 to S_A16 are switched to be conductive, the resistor block 164 in the resistor cell 121A1_1 acts with a total resistance value of 1 kOhm.

For the sake of clarity, not all resistors of the resistors R_A1 to R_A16 and switches of the switches S_A1 to S16 are provided with a reference sign in FIG. 21.

The control unit 153A has four D flip-flops 3A1, 3A2, 3A3, 3A4. One of the bits N_A_1<0:3> of a binary number is connected to the input D of each of the flip-flops 3A1, 3A2, 3A3, 3A4. For the first D flip-flop 3A1 in FIG. 21, the corresponding one bit of the binary number N_A_1<0:3> is designated as A_1_0. For the second D flip-flop 3A2 in FIG. 21, the corresponding one bit of the binary number N_A_1<0:3> is designated as A_1_1. For the third D flip-flop 3A3 in FIG. 21, the corresponding one bit of the binary number N_A_1<0:3> is designated as A_1_2. For the fourth D flip-flop 3A4 in FIG. 21, the corresponding one bit of the binary number N_A_1<0:3> is designated as A_1_3.

The binary number was selected from the memory block 154 by the signal generation unit 1512 in FIG. 20 via the selection signal S_SL. The bits N_A_1<0:3> of the binary number, i.e. the signals A_1_0, A_1_1, A_1_2, A_1_3, control which of the switches of the four resistor arrays 161 to 164 should be conductive after passing through the step, i.e. here step S1. For this purpose, an output Q̅ of the first D flip-flop 3A1 acts on the switch S_A1 of the first resistor block 161. An output Q̅ of the second D flip-flop 3A2 acts on the switches S_A2, S_A3 of the second resistor block 162. An output Q̅ of the third D flip-flop 3A3 acts on the switches S_A4 to S_A7 of the third resistor block 163. An output Q̅ of the fourth D flip-flop 3A4 acts on the switches S_A8 to S_A16 of the fourth resistor block 164.

At the input C of each of the four D flip-flops 3A1, 3A2, 3A3, 3A4 there is a step signal or signal for step S1 as an example.

As soon as a rising edge in the signal for step S1 arrives at the input C of one of the D flip-flops 3A1, 3A2, 3A3, 3A4, the value of the signal at the input D is applied to the inverting output Q̅ because the switches S_A1 to S_A16 in the example shown are designed as PMOS transistors. However, if the switches S_A1 to S_A16 are designed as NMOS transistors, as in the parallel circuits 121B1, 121D1, the output Q is used instead of the output Q̅ to control the switches S_A1 to S16.

This allows at least one of the resistor blocks 161, 162, 163, 164 to be switched on.

The same control is carried out, in particular simultaneously, for the resistor blocks 161, 162, 163, 164 of the resistor cells of the parallel circuits 121B1, 121C1, 121D1. In addition, such control is subsequently carried out for the at least one next step S_X for the resistor blocks 161, 162, 163, 164 of the resistor cells of the parallel circuits 121A1, 121B1, 121C1, 121D1.

When the entire transition is completed, depending on the values controlled and then set by the control part 15, each resistor cell 121A1_1 of the parallel circuit 121A1 can have one of 16 equivalent resistance values between infinity, where all switches S1 to S16 are open, and a resistance value of about 533 ohms, where all switches S1 to S16 are closed. Thus, each resistor array or parallel circuit 121A1 can have a possible equivalent resistance value between infinity, where all switches S1 to S16 are open, and a resistance value of about 18 ohms, where all switches S1 to S16 are closed. The same applies to the parallel circuits 121B1, 121C1, 121D1 and their resistor cells 121A1.

This allows easy adjustments in order to perform calibrations for individual parts as well as for the development of transmitting modules 121 for standards other than those applicable to a CAN bus system. In particular, the transmitting module 121 can represent or generate all static states permitted in CAN XL and/or 10Base-T1S, including their intermediate states. The intermediate states can also be called transition states.

By bundling the individual resistance fingers or resistor elements S_A1, R_A1 etc. into the resistor blocks 161, 162, 163, 164 with the binary coding, there are, with this solution, only 30*4=120 control lines from the logic block 153 to the H-bridge of the transmitting module 121 per array for 450 individual resistance fingers. The transmission module 121 ensures that no more resistance fingers or resistor elements S_A1, R_A1 etc. than necessary switch at once.

This makes it possible to avoid high switching peaks which occur if, for example, the 450 resistance fingers or resistor elements S_A1, R_A1, etc. of a transmitting module 121 were to be controlled directly in binary with 9 lines, such as in a transition from 255 to 256 (binary: 011111111 to 100000000). In such a transition from 255 to 256 (binary: 011111111 to 100000000), conductive fingers would switch each individual line.

A further advantage is that even in the event of unforeseen incomplete transitions, no abrupt changes to the output of the transmitting module 121 are possible. The reason for this is that, even after resetting of the chain, the changes only happen or run step by step. This ensures a continuous output and is therefore good for the emission behavior of the transmitting module 121 and the associated transmitting/receiving device 12.

The circuit implementation of the logic block 153 shown in FIG. 21, which controls a logic function N (X, transition), where N=(N_A, N_B, N_C, N_D) is the vector of active resistance fingers which should be active at step S_X of a selected transition, is only one possible implementation of the logic block 153.

In general, 40 logic functions N (X, transition) can be implemented for all transitions on the bus. The implementations of the different transitions may vary.

In addition, although the circuit implementation of the logic block 153 shown in FIG. 21 is technically simple and robust, it allows only limited large steps or intermediate states for the transition.

The logic block 153 and/or the control of the switches for the resistors of the transmission stages 121A, 121B, 121C, 121D can therefore allow a different design of the steps or intermediate states than that shown in FIG. 20 or described above in Tables 5 and 6. In particular, the logic block 153 and/or the control of the switches for the resistors of the transmission stages 121A, 121B, 121C, 121D can make the size of the steps and/or the duration of the intermediate states more flexible.

### Second Exemplary Embodiment

According to a second exemplary embodiment, for meeting the dielectric strength requirements in the transmission stages 121A, 121B, 121C, 121D of the transmission module 121, the transmission module 121 has no cascodes HVP_A, HVP_B, HVP_C, HVP_D and no diodes D_A, D_B, D_C, D_D. This is possible provided the dielectric strength requirements allow it.

However, it is possible that the dielectric strength requirements for the transmission module 121 and/or the transmission stages 121A, 121B, 121C, 121D of the transmission module 121 are substituted by protection circuits other than the cascodes HVP_A, HVP_B, HVP_C, HVP_D and no diodes D_A, D_B, D_C, D_D.

In this case too, the resistors R_M, R_CP of the transmission module 121 with the transmission stages 121A, 121B, 121C, 121D can be set as described above with respect to the first exemplary embodiment.

### Third Exemplary Embodiment

According to a third exemplary embodiment, the COM-IF detection module 124 is designed to check at least one and up to three of the four criteria mentioned above.

The module 124 can therefore make the decision as to which communication interface should be used by the transmitting/receiving device 12, using fewer than the four criteria mentioned above.

The COM-IF detection module 124 according to the third exemplary embodiment can be used with the transmitting/receiving device 12 according to the first exemplary embodiment. The COM-IF detection module 124 according to the third exemplary embodiment can be used with the transmitting/receiving device 12 according to the first exemplary embodiment.

All above-described embodiments of the transmitting/receiving device 12, of the stations 10, 20, 30, of the bus systems 1, 1A, of the gateway 5, and of the method carried out therein according to the exemplary embodiments and their modifications can be used individually or in all possible combinations. Additionally, the following modifications are conceivable in particular.

The above-described bus systems 1, 1A according to at least one of the exemplary embodiments is described using a bus system based on the CAN protocol or on 10BASE-T1S. However, the bus systems 1, 1A according to the exemplary embodiments may alternatively be another type of communication network in which the signals are transmitted as differential signals.

The evaluation module 16 does not need to be a separate part of the transmitting/receiving device 12. Instead, the evaluation module 16 can be part of the transmission module 121. Alternatively, the evaluation module 16 can be part of any module of the transmitting/receiving device 12.

It is advantageous, but not necessarily a prerequisite, for exclusive, collision-free access of a station 10, 20, 30 to the bus 40 to be ensured in the bus system 1, at least for certain time periods.

The bus system 1 according to at least one of the exemplary embodiments and their modifications is in particular a bus system in which communication can take place between at least two of the stations 10, 20, 30 according to two different CAN standards, such as CAN HS or CAN FD or CAN SIC or CAN XL. The functionality of the above-described exemplary embodiments can thus be used, for example, in transmitting/receiving devices 12, 22 that are to be operated in such a bus system.

The number and arrangement of the stations 10, 20, 30 in the bus system 1 according to at least one of the exemplary embodiments and their modifications can be selected as desired.

What is claimed is:

1. A transmitting/receiving device for a station of a serial bus system, comprising:
a transmission module configured to transmit a digital transmit signal as an analog differential signal to a bus of the bus system to transmit a message to at least one other station of the bus system;
a reception module configured to receive signals from the bus and to generate a digital receive signal from the analog differential signal; and
at least one module for ascertaining which of at least two different communication standards is used on the bus, in order to switch the transmission module and the reception module according to the ascertained communication standard on the bus;
wherein the transmission module includes a full bridge in which a first transmission stage and a fourth transmission stage are connected in series, and a third transmission stage and a second transmission stage are connected in series; and
wherein the transmission module is configured to set resistance values of resistors of the first, the second, the third, and the fourth transmission stages based on an ascertainment result of the at least one module for ascertaining and to generate the analog differential signal with the first to fourth transmission stages set in this way.

2. The transmitting/receiving device according to claim 1, further comprising a control part for controlling the first, the second, the third, and the fourth transmission stages, wherein:
the resistors of the first, the second, the third, and the fourth transmission stages are each formed from a parallel circuit of up to N switchable resistors,
each of the switchable resistors is connected in series with a switch,
N is a natural number greater than 1,
the control part is configured for stepwise control of the switches based on the transmit signal in order to switch states on the bus due to a change in a state of the transmit signal, and
the stepwise control of the switches includes a time-delayed switching on or off of switches of the switches, in which at least two switches of a transmission stage of the first, the second, the third, and the fourth transmission stages are switched together in one step.

3. The transmitting/receiving device according to claim 1, further comprising:
a first terminal for receiving the digital transmit signal from a communication control device; and
a second terminal for outputting the digital receive signal to the communication control device;
wherein the at least one module for ascertaining has a COM-IF detection module and is configured to ascertain whether the digital transmit signal at the first terminal has at least one predetermined property of a communication standard of the at least two different communication standards, for which the transmission module and the reception module are configured for communication in the serial bus system; and
wherein the transmitting/receiving device is configured to switch the second terminal as an output or as an input based on an ascertainment result of the COM-IF detection module.

4. The transmitting/receiving device according to claim 3, further comprising:
a third terminal for setting one of two predetermined voltage levels,
wherein the COM-IF detection module is also configured to ascertain whether the digital transmit signal occurs at the first terminal in combination with a prespecified voltage level of the two predetermined voltage levels at the third terminal.

5. The transmitting/receiving device according to claim 4, wherein, in addition or as an alternative to the COM-IF detection module, the at least one module for ascertaining includes a COM-IF determination module for evaluating, if the transmitting/receiving device is switched to an operating mode in which the transmitting/receiving device can actively carry out communication via at least one of the first, the second, and the third terminals, whether the third terminal is switched as an output or as an input.

6. The transmitting/receiving device according to claim 1, wherein the at least one module for ascertainment has a detection module configured to detect a resistance value of a resistor with which the bus is terminated, and a voltage value of a supply voltage applied to the transmitting/receiving device for voltage supply.

7. The transmitting/receiving device according to claim 5, further comprising an operating mode selection module for selecting an operating mode of the transmission module and/or of the reception module based on an output of the at least one module for ascertaining.

8. The transmitting/receiving device according to claim 7, wherein the operating mode selection module is configured to select the operating mode of the transmission module and/or of the reception module, to evaluate the transmit signal at the first terminal and the voltage level at the third terminal.

9. The transmitting/receiving device according to claim 7, wherein the COM-IF detection module is configured to, after passing a detection result to the operating mode selection module, further evaluate the transmit signal with respect to the at least one predetermined property.

10. The transmitting/receiving device according to claim 1, wherein the transmission module is configured, in one communication standard of the at least two different communication standards, to generate the analog differential signals in a first communication phase of the message with a different physical layer than in a second communication phase.

11. The transmitting/receiving device according to claim 1, wherein:
the at least two different communication standards include CAN XL and 10BASE-T1S, and
the communication standard 10BASE-T1S is at least one of the following communication standards including: 10BASE-T1S multi-drop with a supply voltage of 5 V, 10BASE-T1S multi-drop with a supply voltage of 3.3 V, and 10BASE-T1S single-drop with a supply voltage of 5 V.

12. A station for a serial bus system, comprising:
a transmitting/receiving device, including:
a transmission module configured to transmit a digital transmit signal as an analog differential signal to a bus of the bus system to transmit a message to at least one other station of the bus system,
a reception module configured to receive signals from the bus and to generate a digital receive signal from the analog differential signal, and
at least one module for ascertaining which of at least two different communication standards is used on the bus, in order to switch the transmission module and the reception module according to the ascertained communication standard on the bus,
wherein the transmission module includes a full bridge in which a first transmission stage and a fourth transmission stage are connected in series, and a third transmission stage and a second transmission stage are connected in series, and
wherein the transmission module is configured to set resistance values of resistors of the first, the second, the third, and the fourth transmission stages based on an ascertainment result of the at least one module for ascertaining and to generate the analog differential signal with the first to fourth transmission stages set in this way;
a communication control device configured to control communication in the bus system and to generate the transmit signal;
wherein the station is configured for communication in a bus system in which exclusive, collision-free access of a station to the bus of the bus system is ensured at least temporarily.

13. A gateway for forwarding messages between at least a first bus system and a second bus system, the gateway comprising:
at least two transmitting/receiving devices, each of which including:
a transmission module configured to transmit a digital transmit signal as an analog differential signal to a bus of a bus system of the at least the first bus system and the second bus system, to transmit a message to at least one other station of the bus system,
a reception module configured to receive signals from the bus and to generate a digital receive signal from the analog differential signal, and
at least one module for ascertaining which of at least two different communication standards is used on the bus, in order to switch the transmission module and the reception module according to the ascertained communication standard on the bus,
wherein the transmission module includes a full bridge in which a first transmission stage and a fourth transmission stage are connected in series, and a third transmission stage and a second transmission stage are connected in series, and
wherein the transmission module is configured to set resistance values of resistors of the first, the second, the third, and the fourth transmission stages based on an ascertainment result of the at least one module for ascertaining and to generate the analog differential signal with the first to fourth transmission stages set in this way;
wherein one of the at least two transmitting/receiving devices of the gateway is connected to the first bus system and another of the at least two transmitting/receiving devices is connected to the second bus system.

14. A method for communication using differential signals in a serial bus system, wherein the method is performed using a single transmitting/receiving device for a station of the bus system, the transmitting/receiving device including a transmission module, a reception module, and at least one module for ascertainment, wherein the signal transmission module is configured to transmit a digital transmit signal as an analog differential signal onto a bus of the bus system in order to transmit a message to at least one other station of the bus system, wherein the transmission module includes a full bridge in which a first transmission stage and a fourth transmission stage are connected in series and a third transmission stage and a second transmission stage are connected in series, and wherein the method comprises the following steps:
ascertaining, using the at least one module for ascertainment, which of at least two different communication standards is used on the bus;
setting, in the transmission module, resistance values of resistors of the first, the second, the third, and the fourth transmission stages based on the ascertainment result of the at least one module for ascertainment; and
setting the reception module according to the ascertained communication standard on the bus.

15. The method according to claim 14, further comprising
transmitting, using the transmission module, the transmit signal as an analog differential signal to the bus by using the resistors of the first, the second, the third, and the fourth transmission stages, whose resistance values were set in the setting step; and/or
receiving, using the reception module, analog differential signals from the bus, for outputting a digital receive signal, which is generated according to the communication standard set in the reception module, to the communication control device.
